(19) United States
(12) Patent Application Publication
(10) Pub. No.: US 2026/0292360 A1
(43) Pub. Date: Sep. 24, 2026

(54) SOLID-STATE IMAGING ELEMENT AND METHOD FOR CONTROLLING SOLID-STATE IMAGING ELEMENT

(71) Applicant: Sony Semiconductor Solutions Corporation, Kanagawa (JP)

(72) Inventors: Futa Mochizuki, Kanagawa (JP); Atsumi Niwa, Kanagawa (JP); Ren Hiyoshi, Kanagawa (JP); Manabu Suzuki, Kanagawa (JP); Yuto Shimasaki, Kanagawa (JP)

(21) Appl. No.: 19/475,910

(22) PCT Filed: May 10, 2024
(86) PCT No.: PCT/JP2024/017442

§ 371 Date: Oct. 16, 2025

(30) Foreign Application Priority Data
Jun. 7, 2023 (JP) 2023-094155

(51) Int. Cl. H04N 25/47; H04N 23/71; H04N 25/44; H04N 25/771

(52) U.S. Cl. CPC H04N 25/47; H04N 23/71; H04N 25/44; H04N 25/771

(57) ABSTRACT

Noise suppression in a solid-state imaging element that detects an address event is disclosed. In one example, a solid-state imaging element includes an illuminance meter, a detection pixel, and a parameter control circuit. The illuminance meter measures illuminance. The detection pixel detects whether or not an amount of change in brightness exceeds a predetermined threshold value. The parameter control circuit controls a parameter of the detection pixel in accordance with the illuminance measured by the illuminance meter.

### TECHNICAL FIELD

The present technology relates to a solid-state imaging element. Specifically, the present technology relates to a solid-state imaging element that detects a change in brightness, and a method for controlling the solid-state imaging element.

### BACKGROUND ART

Conventionally, a synchronous solid-state imaging element that captures image data in synchronization with a synchronization signal such as a vertical synchronization signal is used in an imaging device or the like. In this general synchronous solid-state imaging element, image data can only be acquired in every cycle (for example, 1/60 seconds) of a synchronization signal. Therefore, in fields related to transportation, robots, and the like, it is difficult to cope with a case where higher speed processing is required. Therefore, there has been proposed an asynchronous solid-state imaging element that detects an address event in real time for every pixel address, on the basis of whether or not an amount of change in brightness of the pixel exceeds a predetermined threshold value (see, for example, Non-Patent Document 1). As described above, the solid-state imaging element that detects an address event for each pixel is referred to as an event-based vision sensor (EVS) or a dynamic vision sensor (DVS). In this EVS, a buffer or a differentiator is used to obtain an amount of change in brightness, and a comparator is used to compare the amount of change with a threshold value.

### CITATION LIST

### Non-Patent Document

Non-Patent Document 1: Patrick Lichtsteiner, et al., A 128 128 120 dB 15 μs Latency Asynchronous Temporal Contrast Vision Sensor, IEEE JOURNAL OF SOLID-STATE CIRCUITS, VOL. 43, NO. 2, FEBRUARY 2008.

### SUMMARY OF THE INVENTION

### Problems to be Solved by the Invention

In the conventional technology described above, an address event is detected by using a buffer, a differentiator, and a comparator. However, in the EVS described above, noise may occur in a circuit in a dark state. If a bias current and a capacitance value in the circuit are controlled, noise may be reduced. Whereas, however, delay time may be increased. Thus, in the EVS described above, it is difficult to suppress noise.

The present technology has been made in view of such a situation, and an object thereof is to suppress noise in a solid-state imaging element that detects an address event.

### Solutions to Problems

The present technology has been made to solve the above-described problem, and a first aspect thereof is a solid-state imaging element including: an illuminance meter configured to measure illuminance; a detection pixel configured to detect whether or not an amount of change in brightness exceeds a threshold value that is predetermined; and a parameter control circuit configured to control a parameter of the above-described detection pixel in accordance with the above-described measured illuminance. This configuration brings about an effect of suppressing noise.

Furthermore, in this first aspect the above-described detection pixel may include: a photoelectric conversion element configured to generate a photocurrent; a logarithmic response unit configured to convert the above-described photocurrent into a logarithmic voltage; a buffer configured to output an output signal according to the above-described logarithmic voltage; a differentiator configured to differentiate the above-described output signal, and supply a differential signal; and a comparator configured to compare the above-described differential signal with a threshold value that is predetermined. This configuration brings about an effect of detecting an address event.

Furthermore, this first aspect may further include a bias voltage generation circuit configured to generate a bias voltage under control of the above-described parameter control circuit and supply the above-described bias voltage to the above-described detection pixel, and the above-described parameter may include the above-described bias voltage. This configuration brings about an effect of suppressing noise by controlling the bias voltage.

Furthermore, in this first aspect, the above-described bias voltage may include a first bias voltage, and the above-described bias voltage generation circuit may supply the above-described first bias voltage to the above-described buffer. This configuration brings about an effect of suppressing noise by controlling the bias voltage to the buffer.

Furthermore, in this first aspect, the above-described bias voltage may include a second bias voltage, and the above-described bias voltage generation circuit may supply the above-described second bias voltage to the above-described differentiator. This configuration brings about an effect of suppressing noise by controlling the bias voltage to the differentiator.

Furthermore, in this first aspect, the above-described bias voltage may include a third bias voltage, and the above-described bias voltage generation circuit may supply the above-described third bias voltage indicating the above-described threshold value to the above-described comparator. This configuration brings about an effect of suppressing noise by controlling the bias voltage to the comparator.

Furthermore, in this first aspect, the above-described detection pixel may include a variable capacitor, and the above-described parameter may include a capacitance value of the above-described variable capacitor. This configuration brings about an effect of suppressing noise by controlling the capacitance value.

Furthermore, in this first aspect, the above-described variable capacitor may be inserted between an input node and an output node of the above-described logarithmic response unit. This configuration brings about an effect of suppressing noise by controlling the capacitance value.

Furthermore, in this first aspect, the above-described variable capacitor may be inserted between a predetermined reference voltage and an output node of the above-described logarithmic response unit. This configuration brings about an effect of suppressing noise by controlling the capacitance value.

Furthermore, in this first aspect, the above-described parameter control circuit may control the above-described parameter to a different value between a case where the above-described illuminance is within a predetermined range and a case where the above-described illuminance is out of the above-described predetermined range. This configuration brings about an effect of suppressing a peak of noise.

Furthermore, in this first aspect, the above-described detection pixel may be arranged in a pixel array unit, and the above-described illuminance meter may be disposed outside the above-described pixel array unit. This configuration brings about an effect of arranging only the detection pixel in the pixel array unit.

Furthermore, in this first aspect, the above-described illuminance meter may include: an analog signal generation circuit configured to generate an analog signal according to brightness; an analog-to-digital converter configured to convert the above-described analog signal into a digital signal; and an illuminance calculation unit configured to calculate illuminance from the above-described digital signal, and the above-described analog signal generation circuit and the above-described detection pixel may be arranged in a pixel array unit. This configuration brings about an effect of improving measurement accuracy of the illuminance.

Furthermore, in this first aspect, the above-described detection pixel may include a first photoelectric conversion element, and the above-described analog signal generation circuit may include: a transfer transistor configured to transfer a charge from a second photoelectric conversion element to a floating diffusion layer; a reset transistor configured to initialize the above-described floating diffusion layer; an amplifier transistor configured to generate the above-described analog signal by amplifying a voltage of the above-described floating diffusion layer; and a selection transistor configured to supply the above-described analog signal to the above-described analog-to-digital converter in accordance with a selection signal. This configuration brings about an effect of generating a grayscale signal.

Furthermore, in this first aspect, the above-described detection pixel may include a photoelectric conversion element, and the above-described analog signal generation circuit may include: a transfer transistor configured to transfer a charge from the above-described photoelectric conversion element to a floating diffusion layer; a reset transistor configured to initialize the above-described floating diffusion layer; an amplifier transistor configured to generate the above-described analog signal by amplifying a voltage of the above-described floating diffusion layer; and a selection transistor configured to supply the above-described analog signal to the above-described analog-to-digital converter in accordance with a selection signal. This configuration brings about an effect of increasing a light receiving area per pixel.

Furthermore, in this first aspect, the above-described detection pixel may include: a photoelectric conversion element configured to generate a photocurrent; and a logarithmic response unit configured to convert the above-described photocurrent into a logarithmic voltage, and the above-described analog signal generation circuit may include a changeover switch configured to connect between a power supply node of the above-described logarithmic response unit and the above-described analog-to-digital converter. This configuration brings about an effect of reducing a circuit scale of the analog signal generation circuit.

Furthermore, a second aspect of the present technology is a solid-state imaging element including: a measurement unit configured to measure a value of an electric signal and output a measured value; a detection pixel configured to detect whether or not an amount of change in brightness exceeds a threshold value that is predetermined; and a parameter control circuit configured to control a parameter of the above-described detection pixel in accordance with the above-described measured value. This configuration brings about an effect of suppressing noise.

Furthermore, in the second aspect, the above-described measured value may be a value of a current flowing through the above-described detection pixel. This configuration brings about an effect of controlling a parameter in accordance with a current value.

Furthermore, in the second aspect, the above-described measured value may be a value of a voltage at a predetermined node in the above-described detection pixel. This configuration brings about an effect of controlling a parameter in accordance with a voltage value.

Furthermore, a third aspect of the present technology is a solid-state imaging element including: an illuminance meter configured to measure illuminance; a first pixel including a first capacitor; a second pixel including a second capacitor; and a read area selection section configured to read one of the above-described first and second pixels in accordance with the above-described illuminance. This configuration brings about an effect of suppressing noise.

### BRIEF DESCRIPTION OF DRAWINGS

FIG. 1 is a block diagram illustrating a configuration example of an imaging device according to a first embodiment of the present technology.

FIG. 2 is a block diagram illustrating a configuration example of a solid-state imaging element according to the first embodiment of the present technology.

FIG. 3 is a block diagram illustrating a configuration example of an EVS pixel according to the first embodiment of the present technology.

FIG. 4 is a circuit diagram illustrating a configuration example of the EVS pixel according to the first embodiment of the present technology.

FIG. 5 is a block diagram illustrating a configuration example of the EVS pixel having a stacked structure according to the first embodiment of the present technology.

FIG. 6 is a graph illustrating an example of frequency characteristics when a bias voltage is higher than a predetermined value, according to the first embodiment of the present technology.

FIG. 7 is a graph illustrating an example of frequency characteristics when the bias voltage is lower than a predetermined value, according to the first embodiment of the present technology.

FIG. 8 is a graph illustrating an example of a bias current, noise, and a delay according to illuminance, according to the first embodiment of the present technology.

FIG. 9 is a diagram illustrating an example of read control of the EVS pixel according to the first embodiment of the present technology.

FIG. 10 is a flowchart illustrating an example of an operation of the solid-state imaging element according to the first embodiment of the present technology.

FIG. 11 is a circuit diagram illustrating a configuration example of an EVS pixel according to a first modification of the first embodiment of the present technology.

FIG. 12 is a graph illustrating an example of a bias current, noise, and a delay according to illuminance, according to the first modification of the first embodiment of the present technology.

FIG. 13 is a circuit diagram illustrating a configuration example of an EVS pixel according to a second modification of the first embodiment of the present technology.

FIG. 14 is a block diagram illustrating a configuration example of a solid-state imaging element according to a second embodiment of the present technology.

FIG. 15 is a circuit diagram illustrating a configuration example of a logarithmic response unit, according to the second embodiment of the present technology.

FIG. 16 is a circuit diagram illustrating a configuration example of the logarithmic response unit to which a diode-connected nMOS transistor is added, according to the second embodiment of the present technology.

FIG. 17 is a circuit diagram illustrating a configuration example of the logarithmic response unit to which a coupling capacitor and a switch are added, according to the second embodiment of the present technology.

FIG. 18 is a circuit diagram illustrating a configuration example of the logarithmic response unit in which an insertion position of the coupling capacitor is changed, according to the second embodiment of the present technology.

FIG. 19 is a graph illustrating an example of the number of capacitors, noise, and a delay according to illuminance, according to the second embodiment of the present technology.

FIG. 20 is a plan view illustrating an example of a layout of elements in an EVS pixel according to the second embodiment of the present technology.

FIG. 21 is a plan view illustrating an example of a layout of elements in the EVS pixel to which a MOS capacitor is added as the coupling capacitor, according to the second embodiment of the present technology.

FIG. 22 is an example of a circuit diagram of the EVS pixel in a case of switching the logarithmic response unit, according to the second embodiment of the present technology.

FIG. 23 is an example of a circuit diagram of the EVS pixel in a case of switching a sub-pixel, according to the second embodiment of the present technology.

FIG. 24 is a block diagram illustrating a configuration example of a solid-state imaging element according to a first modification of the second embodiment of the present technology.

FIG. 25 is an example of a circuit diagram of an EVS pixel according to the first modification of the second embodiment of the present technology.

FIG. 26 is an example of a circuit diagram of an EVS pixel according to a second modification of the second embodiment of the present technology.

FIG. 27 is an example of a circuit diagram of an EVS pixel according to a third modification of the second embodiment of the present technology.

FIG. 28 is a block diagram illustrating a configuration example of a solid-state imaging element according to a third embodiment of the present technology.

FIG. 29 is a circuit diagram illustrating a configuration example of a light receiving unit and a column analog to digital converter (ADC), according to the third embodiment of the present technology.

FIG. 30 is a plan view illustrating an example of a pixel array unit according to the third embodiment of the present technology.

FIG. 31 is a block diagram illustrating a configuration example of a solid-state imaging element according to a first modification of the third embodiment of the present technology.

FIG. 32 is a circuit diagram illustrating a configuration example of a shared block according to the first modification of the third embodiment of the present technology.

FIG. 33 is a block diagram illustrating a configuration example of a solid-state imaging element according to a second modification of the third embodiment of the present technology.

FIG. 34 is a circuit diagram illustrating a configuration example of an illuminance meter according to the second modification of the third embodiment of the present technology.

FIG. 35 is a block diagram illustrating a schematic configuration example of a vehicle control system.

FIG. 36 is an explanatory diagram illustrating an example of an installation position of an imaging section.

### MODE FOR CARRYING OUT THE INVENTION

Modes for carrying out the present technology (hereinafter referred to as embodiments) will be described hereinafter. The description will be given in the following order.
1. First Embodiment (Example of Controlling Bias Voltage in Accordance with Illuminance)
2. Second Embodiment (Example of Controlling Capacitance Value in Accordance with Illuminance)
3. Third Embodiment (Example of Controlling Bias Voltage in Accordance with Illuminance and Disposing Part of Illuminance Meter in Pixel Array Unit)
4. Example of Application to Mobile Body

### 1. First Embodiment

### Configuration Example of Imaging Device

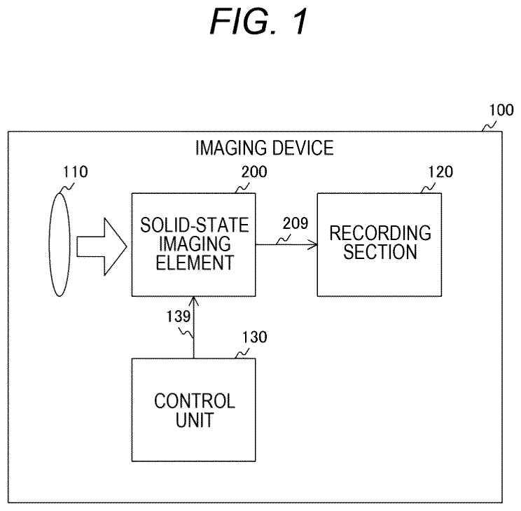

FIG. 1 is a block diagram illustrating a configuration example of an imaging device 100 according to a first embodiment of the present technology. This imaging device 100 includes an imaging lens 110, a solid-state imaging element 200, a recording section 120, and a control unit 130. As the imaging device 100, a smartphone, a camera mounted on an industrial robot, an in-vehicle camera, or the like is assumed.

The imaging lens 110 condenses incident light and guides the light to the solid-state imaging element 200. The solid-state imaging element 200 detects, as an address event, that an amount of change in brightness has exceeded a predetermined threshold value for every pixel address. This solid-state imaging element 200 outputs data indicating a detection result for each pixel to the recording section 120 via a signal line 209.

The recording section 120 records data from the solid-state imaging element 200. The control unit 130 controls the solid-state imaging element 200 to detect an address event.

### Configuration Example of Solid-State Imaging Element

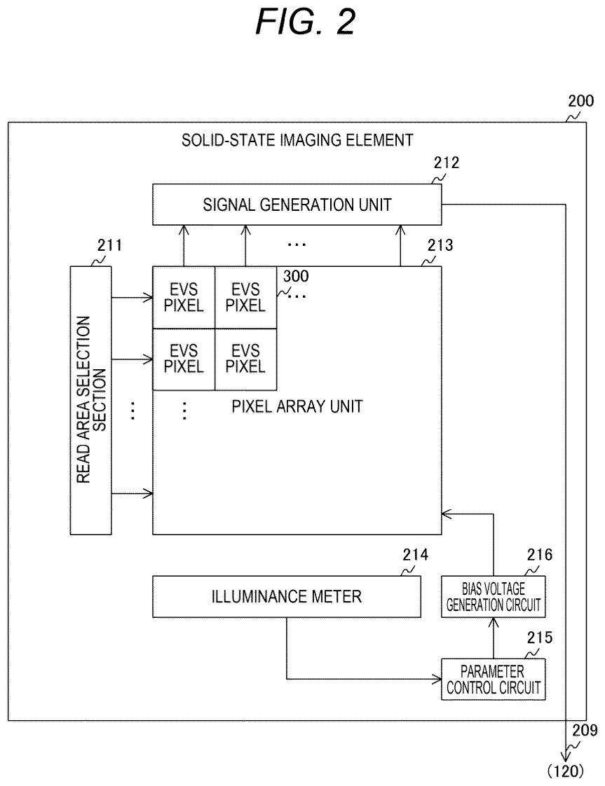

FIG. 2 is a block diagram illustrating a configuration example of the solid-state imaging element 200 according to the first embodiment of the present technology. This solid-state imaging element 200 includes a read area selection section 211, a signal generation unit 212, a pixel array unit 213, an illuminance meter 214, a parameter control circuit 215, and a bias voltage generation circuit 216. In the pixel array unit 213, a plurality of EVS pixels 300 is arranged in a two-dimensional lattice pattern.

The EVS pixel 300 detects whether or not an amount of change in brightness exceeds a predetermined threshold value (in other words, the presence or absence of an address event). This EVS pixel 300 supplies a detection signal indicating a detection result of the address event to the signal generation unit 212. Note that the EVS pixel 300 is an example of a detection pixel described in the claims.

The read area selection section 211 selects some of the plurality of EVS pixels 300 included in the pixel array unit 213. For example, the read area selection section 211 selects any one or a plurality of rows among rows included in a structure of a two-dimensional matrix corresponding to the pixel array unit 213. The read area selection section 211 sequentially selects one or a plurality of rows in accordance with a preset cycle.

On the basis of output signals of the pixels selected by the read area selection section 211, the signal generation unit 212 generates an event signal corresponding to the pixel in which the address event has been detected among the selected pixels.

The signal generation unit 212 can include, for example, a column selection circuit that arbitrates signals entering the signal generation unit 212. Furthermore, the signal generation unit 212 can be configured to output not only information about an active pixel in which the address event has been detected but also information about an inactive pixel in which no address event has been detected.

From the signal generation unit 212, address information and time stamp information (for example, (X, Y, T)) of the active pixel in which the address event has been detected are output via the signal line 209. However, the data output from the signal generation unit 212 may be not only the address information and the time stamp information but also information in a frame format (for example, (0, 0, 1, 0, . . . )).

The illuminance meter 214 measures illuminance of ambient light. This illuminance meter 214 is disposed outside the pixel array unit 213. Furthermore, the illuminance meter 214 is implemented by, for example, a photoelectric conversion element, a transistor, and an analog to digital converter (ADC). The illuminance meter 214 supplies the measured illuminance to the parameter control circuit 215.

The parameter control circuit 215 controls parameters of the EVS pixel 300 in accordance with the illuminance measured by the illuminance meter 214. For example, a bias voltage among various parameters is controlled.

The bias voltage generation circuit 216 generates a bias voltage under the control of the parameter control circuit 215, and supplies the bias voltage to each of the EVS pixels 300 in the pixel array unit 213. Note that, although one bias voltage generation circuit 216 is provided for all the pixels, the pixel array unit 213 may be divided into a plurality of regions, and the bias voltage generation circuit 216 may be provided for each region.

### Configuration Example of EVS Pixel

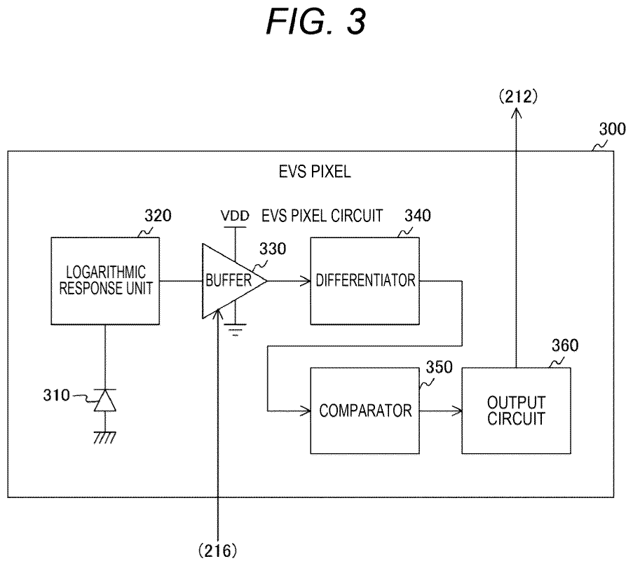

FIG. 3 is a block diagram illustrating a configuration example of an EVS pixel according to the first embodiment of the present technology.

The block diagram illustrates a configuration example of the EVS pixel 300 according to the first embodiment of the present technology. This EVS pixel 300 includes a photoelectric conversion element 310, a logarithmic response unit 320, a buffer 330, a differentiator 340, a comparator 350, and an output circuit 360. The bias voltage from the bias voltage generation circuit 216 is supplied to the buffer 330.

The photoelectric conversion element 310 generates a photocurrent by photoelectric conversion. The logarithmic response unit 320 converts the photocurrent of the photoelectric conversion element 310 into a logarithmic voltage, and supplies the logarithmic voltage to the buffer 330.

The buffer 330 supplies an output signal according to the logarithmic voltage, to the differentiator 340. The differentiator 340 differentiates the output signal of the buffer 330 to generate a differential signal, and supplies the differential signal to the comparator 350.

The comparator 350 compares the differential signal with a predetermined threshold value, and supplies a comparison result to the output circuit 360. The output circuit 360 generates a detection signal on the basis of the comparison result, and outputs the detection signal to the signal generation unit 212. Here, the address event includes, for example, at least one of an on-event indicating that an increase amount of brightness exceeds a threshold value or an off-event indicating that a decrease amount of brightness exceeds the threshold value. Furthermore, the detection signal of the address event includes, for example, at least one of one bit indicating a detection result of the on-event or one bit indicating a detection result of the off-event.

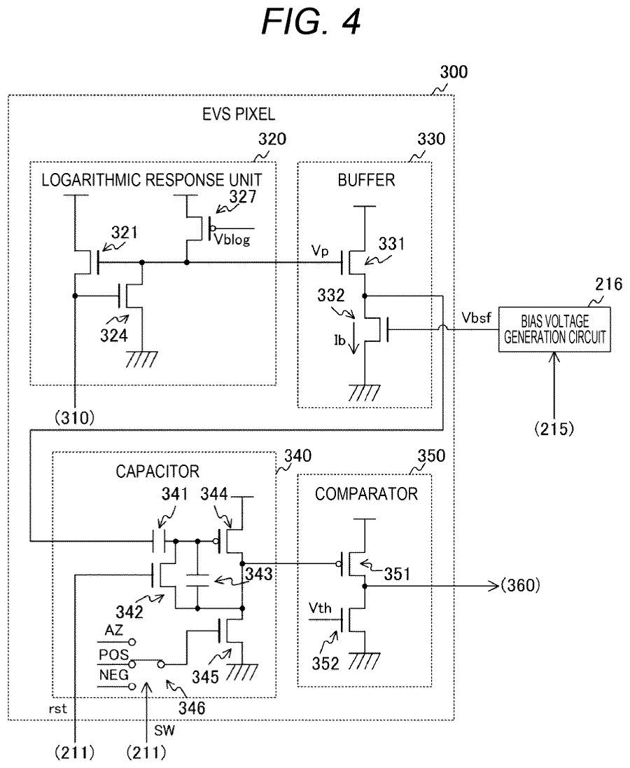

FIG. 4 is a circuit diagram illustrating a configuration example of the EVS pixel 300 according to the first embodiment of the present technology. The logarithmic response unit 320 includes a log transistor 321, a current source transistor 327, and a transimpedance amplifier (TIA) 324. As the log transistor 321 and the TIA 324, for example, n-channel metal oxide semiconductor (nMOS) transistors are used. As the current source transistor 327, for example, a p-channel MOS (pMOS) transistor is used.

The log transistor 321 is inserted between a power supply voltage and the photoelectric conversion element 310. Furthermore, the current source transistor 327 and the TIA 324 are connected in series between the power supply voltage and a reference voltage (such as a ground voltage).

Furthermore, a connection node between the loq transistor 321 and the photoelectric conversion element 310 is connected to a gate of the TIA 324. A connection node between the current source transistor 327 and the TIA 324 is connected to a gate of the log transistor 321 and the buffer 330. A bias voltage Vblog having a fixed value is applied to a gate of the current source transistor 327.

With the circuit configuration described above, the log transistor 321 converts a photocurrent generated by the photoelectric conversion element 310 into a logarithmic voltage. Furthermore, the TIA 324 performs inverting amplification on the logarithmic voltage. Note that, in the figure, a loop circuit including the log transistor 321 and the TIA 324 has one stage, but may have two or more stages as described later.

The buffer 330 includes a source follower transistor 331 and an nMOS transistor 332. As the source follower transistor, for example, an nMOS transistor is used.

The source follower transistor 331 and the nMOS transistor 332 are connected in series between the power supply voltage and the reference voltage. A logarithmic voltage Vp from the logarithmic response unit 320 is input to a gate of the source follower transistor 331, and a source of the source follower transistor 331 is connected to the differentiator 340. A bias voltage Vbsf generated by the bias voltage generation circuit 216 is input to a gate of the nMOS transistor 332.

With the circuit configuration described above, the source follower transistor 331 supplies an output signal according to the logarithmic voltage Vp to the differentiator 340. Furthermore, the nMOS transistor 332 supplies a bias current Ib according to the bias voltage Vbsf. The parameter control circuit 215 controls the bias voltage Vbsf in accordance with illuminance. Details of control contents will be described later. Note that the bias voltage Vbsf is an example of a first bias voltage described in the claims.

The differentiator 340 includes capacitors 341 and 343, a pMOS transistor 344, nMOS transistors 342 and 345, and a bias changeover switch 346.

One end of the capacitor 341 is connected to the buffer 330, and another end is connected to one end of the capacitor 343 and a gate of the pMOS transistor 344. A reset signal rst is input to a gate of the nMOS transistor 342, while a source and a drain are connected to both ends of the capacitor 343. The pMOS transistor 344 and the nMOS transistor 345 are connected in series between the power supply voltage and the reference voltage. Furthermore, another end of the capacitor 343 is connected to a connection point between the pMOS transistor 344 and the nMOS transistor 345. A bias voltage from the bias changeover switch 346 is applied to a gate of the nMOS transistor 345 on the reference voltage side, and a connection point between the pMOS transistor 344 and the nMOS transistor 345 is also connected to the comparator 350.

The nMOS transistor 345 supplies a bias current according to a bias voltage. The bias changeover switch 346 selects any of bias voltages AZ, POS, and NEG in accordance with a selection signal SW from the read area selection section 211, and supplies the bias voltage to the nMOS transistor 345. The bias voltage AZ is supplied at a time of auto-zero. The bias voltage POS is supplied in a detection period of the on-event, and the bias voltage NEG is supplied in a detection period of the off-event. These bias voltages are assumed to be fixed values.

With the circuit configuration described above, the differentiator 340 generates a differential signal indicating an increase amount of brightness during the detection period of the on-event, and outputs the differential signal to the comparator 350. Furthermore, the differentiator 340 generates a differential signal indicating a decrease amount of brightness during the detection period of the off-event, and outputs the differential signal to the comparator 350. Furthermore, the differential signal is initialized with the reset signal rst from the read area selection section 211.

The comparator 350 includes a pMOS transistor 351 and an nMOS transistor 352. The pMOS transistor 351 and the nMOS transistor 352 are connected in series between the power supply voltage and the reference voltage.

A differential signal from the differentiator 340 is input to a gate of the pMOS transistor 351 on the power supply side. A bias voltage Vth whose value corresponds to a threshold value is input to a gate of the nMOS transistor 352. This bias voltage Vth is assumed to be a fixed value. Furthermore, a voltage at the connection point between the pMOS transistor 351 and the nMOS transistor 352 is output to the output circuit 360 as a comparison result.

With the circuit configuration described above, the comparator 350 compares a differential signal indicating an increase amount or a decrease amount of brightness with a value of the bias voltage Vth (that is, a threshold value), and outputs a comparison result to the output circuit 360.

Note that the circuits in the solid-state imaging element 200 can also be dispersedly disposed on a plurality of semiconductor chips.

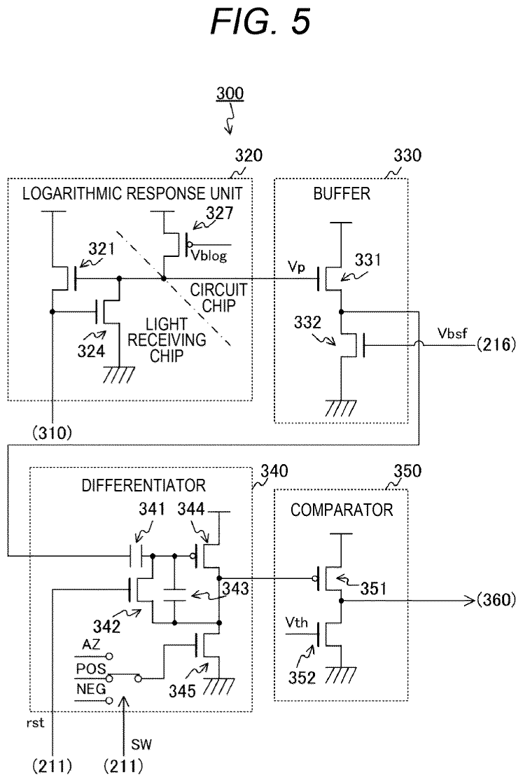

In that case, for example, as illustrated in FIG. 5, a light receiving chip and a circuit chip are stacked. Then, the photoelectric conversion element 310, the log transistor 321, and the TIA 324 are disposed on the light receiving chip, and circuits in and after the current source transistor 327 are disposed on the circuit chip.

Next, frequency characteristics of the logarithmic response unit 320 and the buffer 330 will be described.

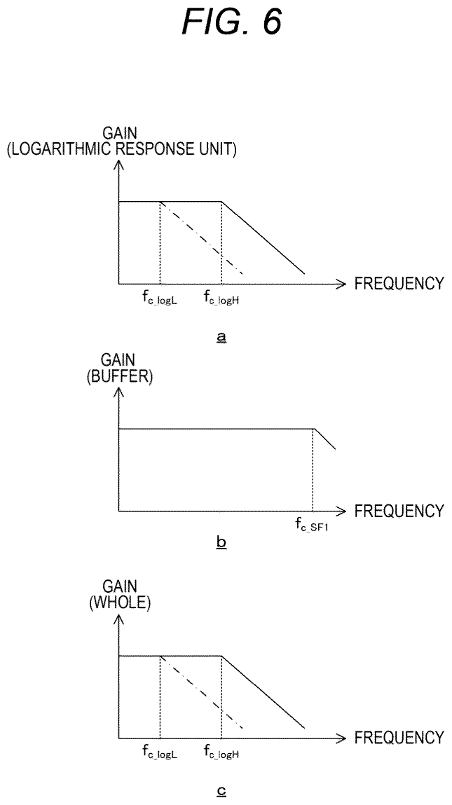

FIG. 6 is a graph illustrating an example of frequency characteristics when the bias voltage Vbsf is Vbsf1 that is higher than a predetermined value, according to the first embodiment of the present technology. In the figure, “a” indicates a frequency characteristic of the logarithmic response unit 320, and “b” indicates a frequency characteristic of the buffer 330. In the figure, “c” illustrates a frequency characteristic of the whole circuit including the logarithmic response unit 320 and the buffer 330. In “a”, “b”, and “c” in the figure, a vertical axis represents a gain, and a horizontal axis represents a frequency.

As illustrated in “a” in the figure, in the logarithmic response unit 320, the gain is constant in a frequency band equal to or lower than a cutoff frequency, and the gain decreases according to a frequency in a frequency band higher than the cutoff frequency. However, the cutoff frequency becomes higher as the illuminance is higher, and the cutoff frequency when the illuminance is relatively high is defined as f_{c_logH}, and the cutoff frequency when the illuminance is relatively low is defined as f_{c_logL}.

As illustrated in “b” in the figure, in the buffer 330, the gain is constant in a frequency band of a cutoff frequency f_{c_SF1} or less, and the gain decreases according to a frequency in a frequency band higher than the cutoff frequency f_{c_SF1}. This cutoff frequency fo spi is constant regardless of the illuminance. Furthermore, Vbsf1 is set to a value at which the cutoff frequency f_{c_SF1} is higher than f_{c_logH}.

As illustrated in “c” in the figure, in the whole circuit, the frequency characteristic of the logarithmic response unit 320 having the lower cutoff frequency is dominant., in other words, the logarithmic response unit 320 having a narrower frequency band in which a signal is allowed to pass is dominant.

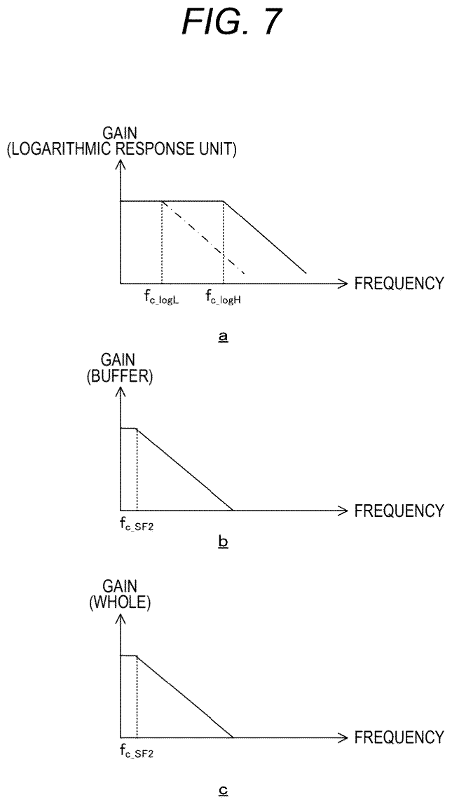

FIG. 7 is a graph illustrating an example of frequency characteristics when the bias voltage Vbsf is Vbsf2 that is lower than a predetermined value, according to the first embodiment of the present technology. In the figure, “a” indicates a frequency characteristic of the logarithmic response unit 320, and “b” indicates a frequency characteristic of the buffer 330. In the figure, “c” illustrates a frequency characteristic of the whole circuit including the logarithmic response unit 320 and the buffer 330. In “a”, “b”, and “c” in the figure, a vertical axis represents a gain, and a horizontal axis represents a frequency.

As illustrated in “a” in the figure, a cutoff frequency of the logarithmic response unit 320 changes according to the illuminance.

As illustrated in “b” in the figure, a cutoff frequency f_{c_SF2} of the buffer 330 is constant regardless of the illuminance. Vbsf2 is set to a value at which this cutoff frequency f_{c_SF2} is lower than f_{c_logL}.

As illustrated in “c” in the figure, a frequency characteristic of the buffer 330 having a narrower frequency band is dominant in the whole circuit.

As illustrated in FIGS. 6 and 7, the frequency band can be narrowed by controlling the bias voltage Vbsf to the lower Vbsf2.

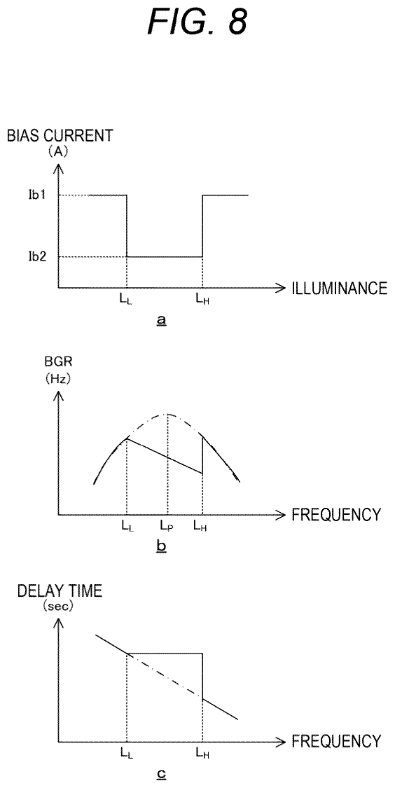

FIG. 8 is a graph illustrating an example of a bias current, noise, and delay time according to illuminance, according to the first embodiment of the present technology. In the figure, “a” is a graph illustrating an example of a relationship between illuminance and a bias current in the buffer 330. In “a” in the figure, a vertical axis represents the bias current, and a horizontal axis represents the illuminance.

In the figure, “b” is a graph illustrating an example of a relationship between illuminance and noise generated in a dark state. In “b” in the figure, a vertical axis represents a background rate (BGR) of noise, and a horizontal axis represents a frequency. Furthermore, a dash-dotted line indicates BGR in a case where the bias voltage Vbsf to the buffer 330 is set to a fixed value, and a solid line indicates BGR in a case where the bias voltage Vbaf is controlled so as to generate the bias current of “a” in the figure.

In the figure, “c” is a graph illustrating an example of a relationship between illuminance and delay time of the EVS pixel 300. In “c” in the figure, a vertical axis represents delay time, and a horizontal axis represents a frequency. Furthermore, a dash-dotted line indicates delay time in a case where the bias voltage Vbsf to the buffer 330 is set to a fixed value, and a solid line indicates delay time in a case where the bias voltage Vbsf is controlled so as to generate the bias current of “a” in the figure.

As illustrated in “b” in the figure, the BGR is higher as the illuminance is higher, and reaches a peak value at a certain illuminance L_{P}. After this L_{P} is exceeded, the BGR decreases as the illuminance increases. A range from L_{L} to L_{H} including this L_{P} is set as a range in which noise should be suppressed.

As illustrated in “a” in the figure, in a case where the illuminance is within the range from L_{L} to L_{H}, the parameter control circuit 215 controls to generate the bias voltage Vbsf2 and decrease the bias current to Ib2 that is lower than a predetermined value. Whereas, in a case where the illuminance is out of the range from L_{L} to L_{H}, the parameter control circuit 215 controls to generate the bias voltage Vbsf1 and increase the bias current to Ib1 that is higher than the predetermined value. As described above, by controlling the bias voltage Vbsf to the lower Vbsf2, the frequency band in which a signal is allowed to pass can be narrowed. Therefore, by lowering the bias voltage within the range from L_{L} to L_{H}, the parameter control circuit 215 can suppress a peak of noise as compared with the case where the bias voltage is set to a fixed value. Moreover, since the peak can be sufficiently suppressed, the frequency band of the logarithmic response unit 320 can be slightly narrowed. By narrowing the frequency band, the delay time at illuminance lower than L_{L} can be reduced.

Note that, as illustrated in “c” in the figure, by lowering the bias voltage, the delay time becomes longer in the range from L_{L} to I_{H} than in the case where the bias voltage is set to a fixed value.

### Operation Example of Solid-State Imaging Element

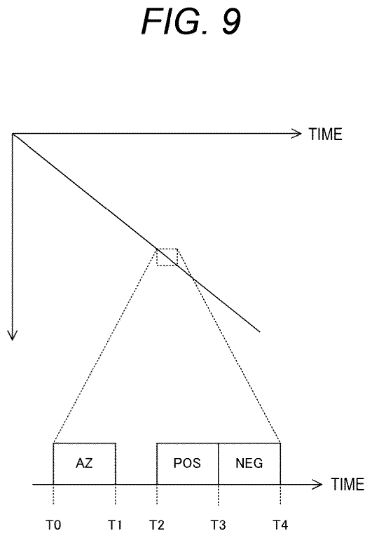

FIG. 9 is a diagram illustrating an example of read control of the EVS pixel 300 according to the first embodiment of the present technology. For example, the read area selection section 211 sequentially selects rows in the pixel array unit 213 one by one, and causes an address event to be detected for each of the EVS pixels 300 in the row. Note that the read area selection section 211 can also sequentially select n rows (n is an integer of 2 or more) at a time.

In a selection period of a certain row, the read area selection section 211 supplies the reset signal rst to the row in an auto-zero period from time T0 to time T1, and switches the bias voltage in the differentiator 340 to AZ.

Then, the read area selection section 211 switches the bias voltage in the differentiator 340 to the POS in a detection period of the on-event from the time T2 to T3. In a detection period of the off-event from time 3 to T4, the read area selection section 211 switches the bias voltage in the differentiator 340 to NEG. AS illustrated in the figure, the technique of sequentially reading on a row-by-row basis is called a scan method.

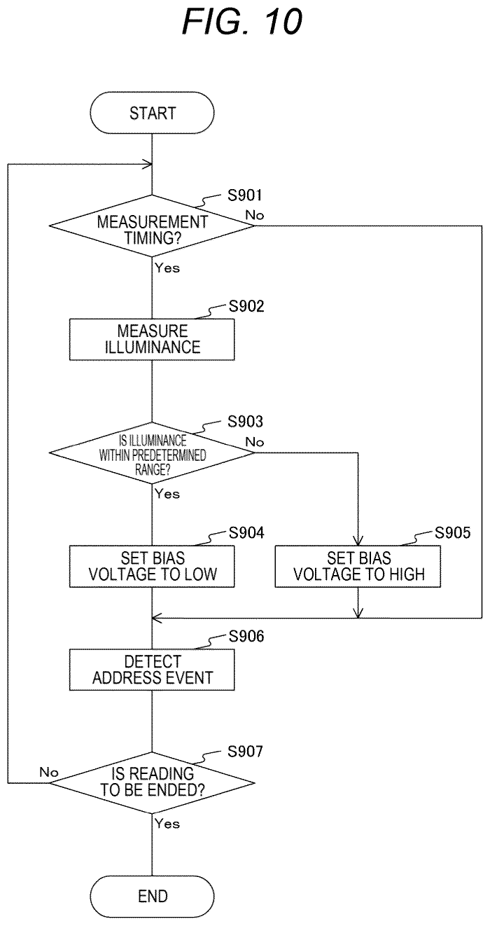

FIG. 10 is a flowchart illustrating an example of an operation of the solid-state imaging element 200 according to the first embodiment of the present technology. This operation is started, for example, when a predetermined application for detecting an address event is executed.

The illuminance meter 214 determines whether or not the current time is an illuminance measurement timing (step S901). The illuminance is measured, for example, at every regular interval. In a case where it is the illuminance measurement timing (step S901: Yes), the illuminance meter 214 measures the illuminance (step S902). The parameter control circuit 215 determines whether or not the measured illuminance is within the predetermined range from Li to La (step S903). In a case where the illuminance is within the predetermined range (step S903: Yes), the parameter control circuit 215 sets the bias voltage to be lower than a predetermined value (step S904). Whereas, in a case where the illuminance is out of the predetermined range (step S903: No), the parameter control circuit 215 sets the bias voltage to be higher than the predetermined value (step S905).

In a case where it is not the illuminance measurement timing (step S901: No), or after step S904 or S905, the read area selection section 211 causes an address event to be detected on a row-by-row basis (step S906). After step S906, the read area selection section 211 determines whether or not to end the reading (step S906).

In a case where the reading is not to be ended (step S907: No), the read area selection section 211 returns to step S901. Whereas, in a case where the reading is to be ended (step S907: No), the solid-state imaging element 200 ends the operation for detecting the address event.

As described above, according to the first embodiment of the present technology, the parameter control circuit 215 controls the bias voltage Vbsf to the buffer 330 in accordance with the illuminance, so that noise can be suppressed.

### First Modification

In the first embodiment described above, the parameter control circuit 215 controls the bias voltage Vbsf to the buffer 330, but the present disclosure is not limited to this configuration. A parameter control circuit 215 according to a first modification of the first embodiment is different from that of the first embodiment in that a bias voltage to a differentiator 340 is controlled.

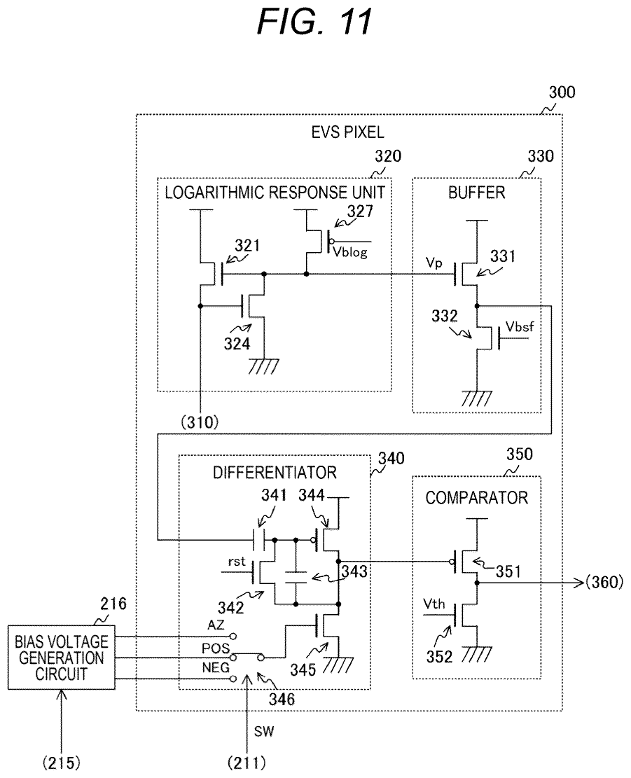

FIG. 11 is a circuit diagram illustrating a configuration example of an EVS pixel 300 according to the first modification of the first embodiment of the present technology. In the EVS pixel 300 according to the first modification of the first embodiment, a bias voltage Vbsf having a fixed value is applied to a buffer 330. Whereas, a bias voltage generation circuit 216 generates bias voltages AZ, POS, and NEG to the differentiator 340. The parameter control circuit 215 controls the bias voltages POS and NEG in accordance with illuminance. A fixed value is set to the bias voltage AZ. Note that the bias voltages POS and NEG are examples of a second bias voltage described in the claims.

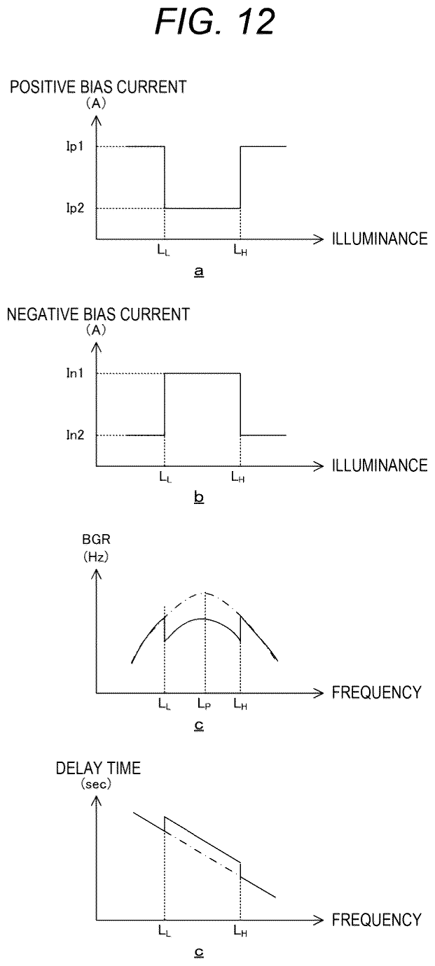

FIG. 12 is a graph illustrating an example of a bias current, noise, and a delay according to illuminance according to the first modification of the first embodiment of the present technology.

In the figure, “a” is a graph illustrating an example of a relationship between a positive bias current and illuminance according to the bias voltage POS. In the figure, “a” is a graph illustrating an example of a relationship between a negative bias current and illuminance according to the bias voltage NEG. In “a” and “b” in the figure, a vertical axis represents the bias current, and a horizontal axis represents the illuminance.

In the figure, “c” is a graph illustrating an example of a relationship between illuminance and noise generated in a dark state. In “c” in the figure, a vertical axis represents BGR of noise, and a horizontal axis represents a frequency. Furthermore, a dash-dotted line indicates BGR in a case where the bias voltages POS and NEG are fixed values, and a solid line indicates BGR in a case where the bias voltage POS or NEG is controlled so as to generate the bias current of “a” or “b” in the figure.

In the figure, “d” is a graph illustrating an example of a relationship between illuminance and delay time of the EVS pixel 300. In “d” in the figure, a vertical axis represents delay time, and a horizontal axis represents a frequency. Furthermore, a dash-dotted line indicates delay time in a case where the bias voltages POS and NEG are fixed values, and a solid line indicates delay time in a case where the bias voltage POS or NEG is controlled so as to generate the bias current of “a” or “b” in the figure.

As illustrated in “a” in the figure, in a case where the illuminance is within the range from L_{L} to L_{H} in a detection period of the on-event, the parameter control circuit 215 controls to generate a bias voltage POS2 and decrease the positive bias current to Ip2 that is lower than a predetermined value. Whereas, in a case where the illuminance is out of the range from L_{L} to L_{H}, the parameter control circuit 215 controls to generate a bias voltage POS1 that is higher than POS2 and increase the positive bias current to Ip1 that is higher than the predetermined value.

Furthermore, as illustrated in “b” in the figure, in a case where the illuminance is within the range from L_{L} to L_{H} in the detection period of the off-event, the parameter control circuit 215 controls to generate a bias voltage NEG1 and increase the negative bias current to In1 that is higher than a predetermined value. Whereas, in a case where the illuminance is out of the range from L_{L} to L_{H}, the parameter control circuit 215 controls to generate a bias voltage NEG2 that is lower than the NEG1 and decrease the bias current to In2 that is lower than the predetermined value.

By the control illustrated in “a” and “b” in the figure, as illustrated in “c” in the figure, a peak of noise can be suppressed as compared with the case where the bias voltages POS and NEG are fixed values.

Note that, as illustrated in “d” in the figure, by making the bias voltage variable, the delay time becomes longer in the range from L_{L} to L_{H} than in the case where the bias voltage is set to a fixed value.

Note that, in the first modification of the first embodiment, in addition to the bias voltages POS and NEG, the parameter control circuit 215 can also control the bias voltage Vbsf to the buffer 330 in accordance with the illuminance.

Furthermore, the EVS pixel 300 detects both the on-event and the off-event, but can also detect only one of these. In this case, the parameter control circuit 215 controls only one of the bias voltages POS and NEG.

As described above, according to the first modification of the first embodiment of the present technology, since the bias voltages POS and NEG to the differentiator 340 are controlled in accordance with the illuminance, noise can be suppressed.

### Second Modification

In the first embodiment described above, the parameter control circuit 215 controls the bias voltage Vbsf to the buffer 330, but the present disclosure is not limited to this configuration. A parameter control circuit 215 according to a second modification of the first embodiment is different from that of the first embodiment in that a bias voltage to a comparator 350 is controlled.

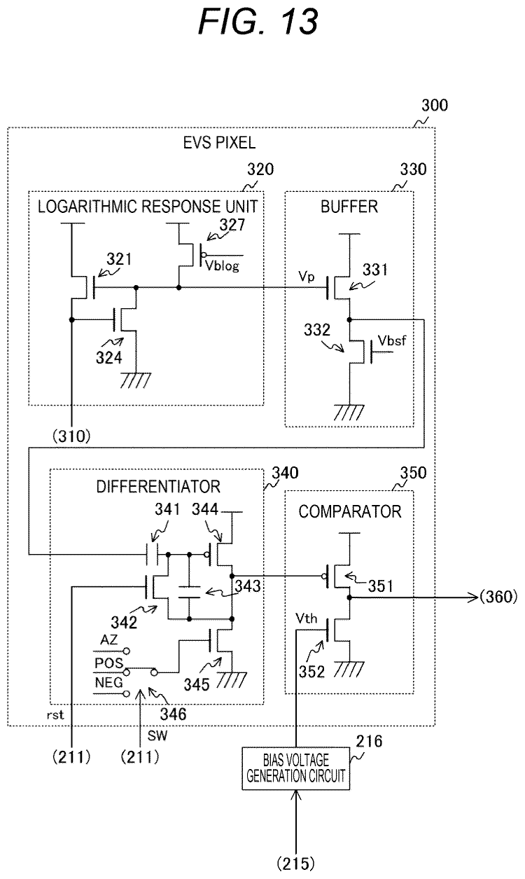

FIG. 13 is a circuit diagram illustrating a configuration example of an EVS pixel 300 according to the second modification of the first embodiment of the present technology. In the EVS pixel 300 according to the second modification of the first embodiment, a bias voltage Vbsf having a fixed value is applied to a buffer 330. Whereas, a bias voltage generation circuit 216 generates a bias voltage Vth to the comparator 350. The parameter control circuit 215 controls a value (threshold value) of the bias voltage Vth in accordance with illuminance. Note that the bias voltage Vth is an example of a third bias voltage described in the claims.

A method for controlling the bias voltage Vth is similar to the method for controlling the bias voltage Vbsf according to the first embodiment.

Note that, in the first modification of the first embodiment, in addition to the bias voltage Vth to the comparator 350, the parameter control circuit 215 can also control a bias voltage of at least one of the buffer 330 or a differentiator 340 in accordance with illuminance.

As described above, according to the first modification of the first embodiment of the present technology, since the bias voltage Vth to the comparator 350 is controlled in accordance with illuminance, noise can be suppressed.

### 2. Second Embodiment

In the first embodiment described above, the parameter control circuit 215 controls the bias voltage Vbsf to the buffer 330, but can also control parameters other than the bias voltage. A parameter control circuit 215 according to a second embodiment is different from that in the first embodiment in that a capacitance value of a logarithmic response unit 320 is controlled.

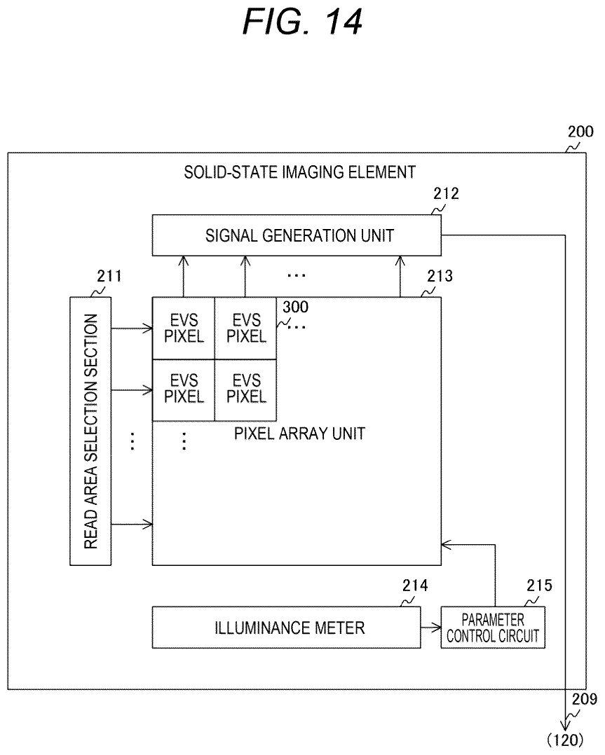

FIG. 14 is a block diagram illustrating a configuration example of a solid-state imaging element 200 according to the second embodiment of the present technology. The bias voltage generation circuit 216 is not disposed in the solid-state imaging element 200 in the second embodiment. Furthermore, the parameter control circuit 215 controls a capacitance value of a variable capacitor (not illustrated) in an EVS pixel 300 in accordance with illuminance.

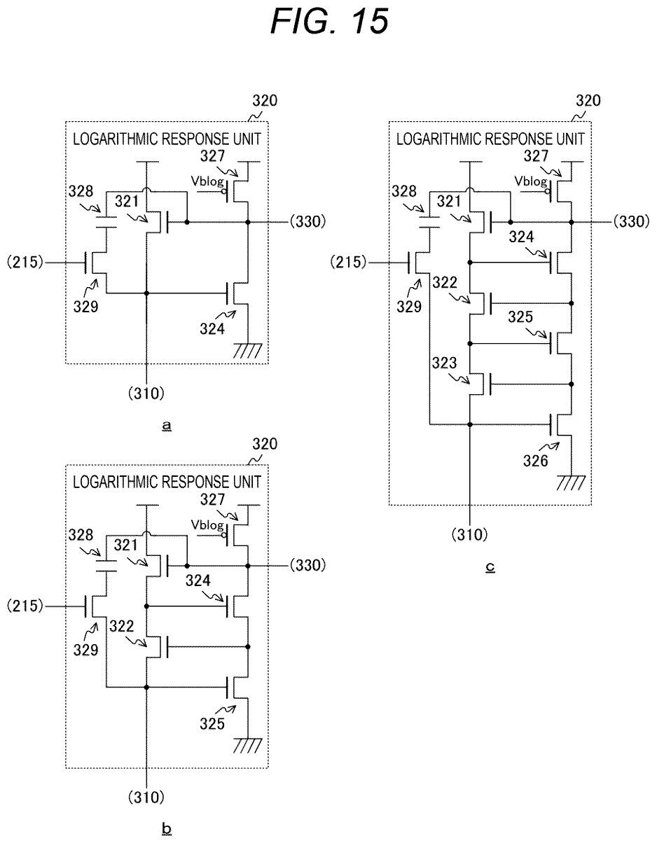

FIG. 15 is a circuit diagram illustrating a configuration example of the logarithmic response unit 320 according to the second embodiment of the present technology. In the figure, “a” is an example of the logarithmic response unit 320 in which a loop circuit has one stage. In the figure, “b” is an example of the logarithmic response unit 320 in which a loop circuit has two stages. In the figure, “c” is an example of the logarithmic response unit 320 in which a loop circuit has three stages.

As illustrated in “a” in the figure, the logarithmic response unit 320 according to the second embodiment is different from that of the first embodiment in further including a coupling capacitor 328 and a switch 329. The coupling capacitor 328 is inserted between the switch 329 and a connection point (in other words, an output node) between a current source transistor 327 and a TIA 324. Furthermore, a bias voltage Vbsf having a fixed value is applied to a buffer 330 (not illustrated) in the subsequent stage.

The switch 329 opens and closes a path between the coupling capacitor 328 and a connection point (in other words, an input node) between a log transistor 321 and a photoelectric conversion element 310, under the control of the parameter control circuit 215.

The parameter control circuit 215 turns on and off the switch 329 in accordance with illuminance. For example, the parameter control circuit 215 controls the switch 329 to the off state in a case where the illuminance is low illuminance lower than a threshold value, and turns the switch 329 to the on state to insert the coupling capacitor 328 in a case where the illuminance is high illuminance equal to or higher than the threshold value.

Note that, in “a” in the figure, a loop circuit including the log transistor 321 and the TIA 324 has one stage, but the loop circuit is not limited to one stage.

For example, as illustrated in “b” in the figure, a log transistor 322 and a TIA 325 may be added to form the loop circuit of two stages. In “b” in the figure, the log transistor 322 is inserted between the log transistor 321 and the input node, and the TIA 325 is inserted between the TIA 324 and a reference voltage (such as a ground voltage). Furthermore, a gate of the log transistor 322 is connected to a connection point between the TIAs 324 and 325, and a gate of the TIA 325 is connected to the input node.

Furthermore, as illustrated in “c” in the figure, a log transistor 323 and a TIA 326 may be further added to form the loop circuit of three stages. In “c” in the figure, the log transistor 323 is inserted between the log transistor 322 and the input node, and the TIA 326 is inserted between the TIA 325 and the reference voltage. Furthermore, a gate of the log transistor 323 is connected to a connection point between the TIAs 325 and 326, and a gate of the TIA 326 is connected to the input node. Furthermore, the loop circuit may have four or more stages.

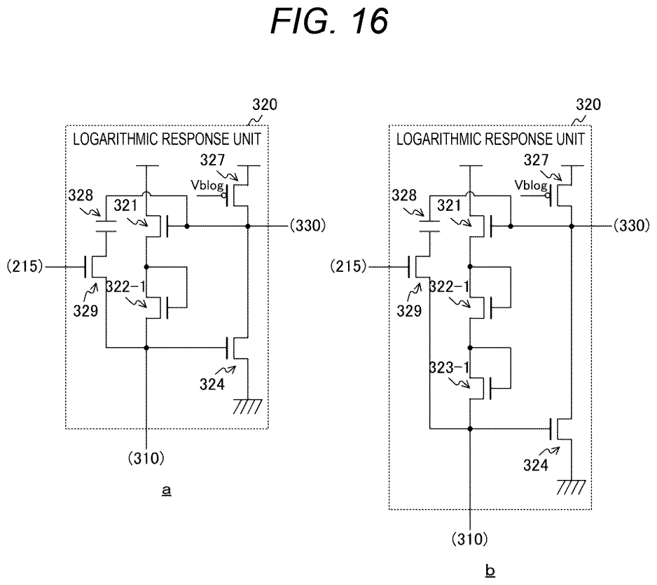

Furthermore, as illustrated in “a” and “b” of FIG. 16, a diode-connected nMOS transistor can also be inserted. In “a” in the figure, an nMOS transistor 322-1 diode-connected between the log transistor 321 and the input node is added. In “b” in the figure, an nMOS transistor 323-1 diode-connected between the nMOS transistor 322-1 and the input node is further added. The diode-connected nMOS transistors may have three stages or more.

Furthermore, in FIGS. 15 and 16, each of the number of the coupling capacitors 328 and the number of the switches 329 is one, but may be two or more.

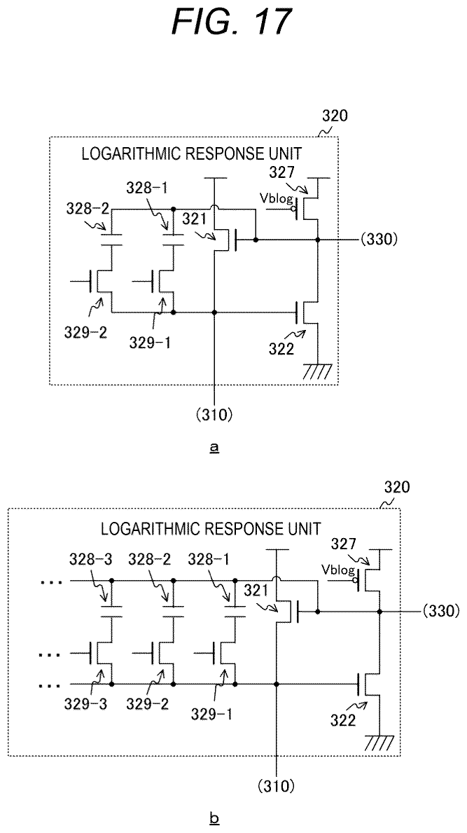

FIG. 17 is a circuit diagram illustrating a configuration example of a logarithmic response unit to which a coupling capacitor and a switch are added, according to the second embodiment of the present technology. In “a” in the figure, coupling capacitors 328-1 and 328-2 and switches 329-1 and 329-2 are added. One ends of the coupling capacitors 328-1 and 328-2 are connected in common to the output node. Furthermore, the switch 329-1 opens and closes a path between another end of the coupling capacitor 328-1 and the input node, and the switch 329-2 opens and closes a path between another end of the coupling capacitor 328-2 and the input node.

In “b” in the figure, three or more sets of coupling capacitors and switches are added. The parameter control circuit 215 can individually open and close each of the plurality of switches. By the control of these switches, the number of coupling capacitors connected in parallel between the input node and the output node increases or decreases, and a composite capacitor of these changes. Note that the coupling capacitor is an example of a variable capacitor described in the claims.

Note that “a” and “b” in FIG. 17 can be freely applied to “a”, “b”, and “c” in FIG. 15 and “a” and “b” in FIG. 16.

Furthermore, as long as the capacitor can be made variable, the circuit configuration of the logarithmic response unit 320 is not limited to those illustrated in FIGS. 15 to 17.

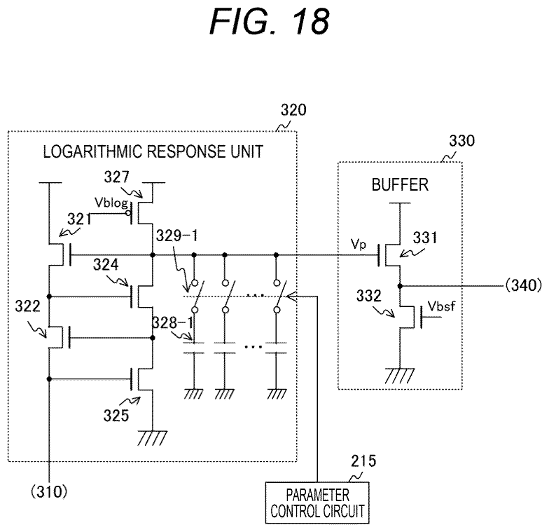

For example, as illustrated in FIG. 18, M pieces of (M is an integer) switches such as the switch 329-1 and M pieces of coupling capacitors such as the coupling capacitor 328-1 can also be inserted between the output node and the reference voltage.

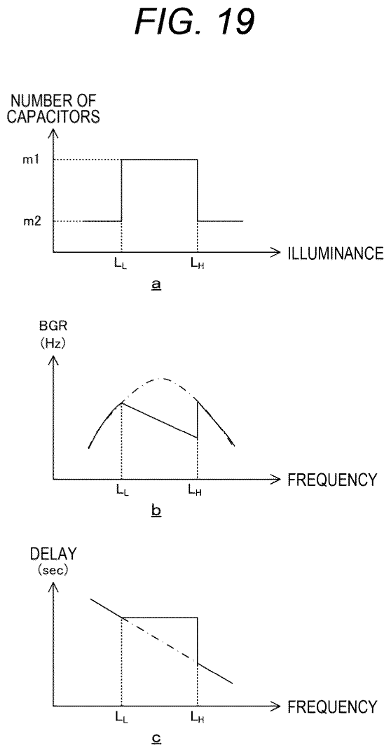

FIG. 19 is a graph illustrating an example of the number of capacitors, noise, and a delay according to illuminance, according to a first modification of the second embodiment of the present technology. In the figure, “a” is a graph illustrating an example of a relationship between illuminance and the number of capacitors connected in parallel. In “a” in the figure, a vertical axis represents the number of capacitors, and a horizontal axis represents the illuminance.

In the figure, “b” is a graph illustrating an example of a relationship between illuminance and noise generated in a dark state. In “b” in the figure, a vertical axis represents BGR of noise, and a horizontal axis represents a frequency. Furthermore, a dash-dotted line indicates BGR in a case where the number of capacitors of the logarithmic response unit 320 is a fixed value, and a solid line indicates BGR in a case where the number of capacitors is controlled as illustrated in “a” in the figure.

In the figure, “c” is a graph illustrating an example of a relationship between illuminance and delay time of the EVS pixel 300. In “c” in the figure, a vertical axis represents delay time, and a horizontal axis represents a frequency. Furthermore, a dash-dotted line indicates delay time in a case where the number of capacitors of the logarithmic response unit 320 is a fixed value, and a solid line indicates delay time in a case where the number of capacitors is controlled as illustrated in “a” in the figure.

As illustrated in “a” in the figure, in a case where the illuminance is within a range from LE to La, the parameter control circuit 215 sets the number of capacitors to ml, which is larger than a predetermined value, and increases a capacitance value of the composite capacitor. Whereas, in a case where the illuminance is out of the range from L_{L} to L_{H}, the parameter control circuit 215 sets the number of capacitors to m2, which is smaller than the predetermined value, and decreases the capacitance value of the composite capacitor. By this control, as illustrated in “b” in the figure, it is possible to suppress a peak of noise as compared with a case where the number of capacitors is a fixed value.

Note that, as illustrated in “c” in the figure, by making the capacitance value variable, the delay time becomes longer within the range from L_{L} to L_{H} than in the case where the capacitance value is a fixed value.

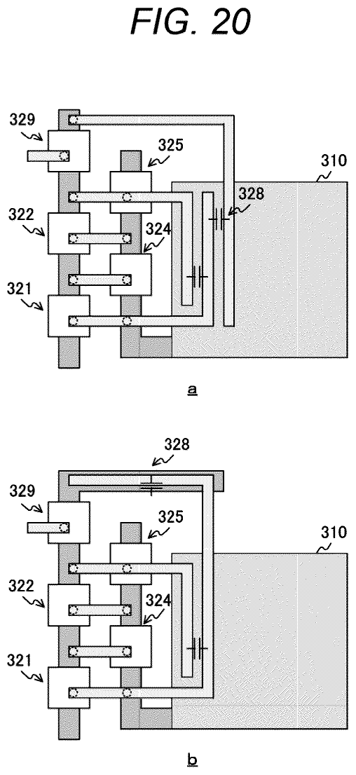

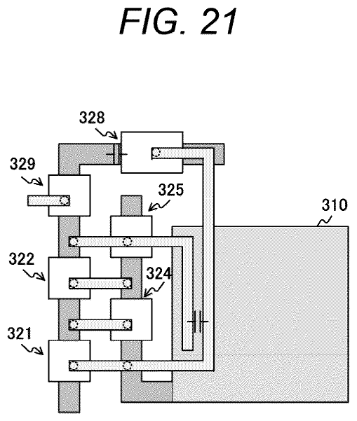

Next, a method for implementing the coupling capacitor 328 will be described with reference to FIGS. 20 and 21. For example, as illustrated in “a” of FIG. 20, a wiring capacitor can be added as the coupling capacitor 328. In the figure, “a” illustrates a layout of the photoelectric conversion element 310, the log transistors 321 and 322, the TIAS 324 and 325, the switch 329, and the coupling capacitor 328. Alternatively, as illustrated in “b” in the figure, a diffusion capacitor can be added as the coupling capacitor 328.

Alternatively, as illustrated in FIG. 21, a MOS capacitor can be added as the coupling capacitor 328.

Furthermore, in FIGS. 15 to 21, the coupling capacitor in the logarithmic response unit 320 is variable, but the present disclosure is not limited to this configuration.

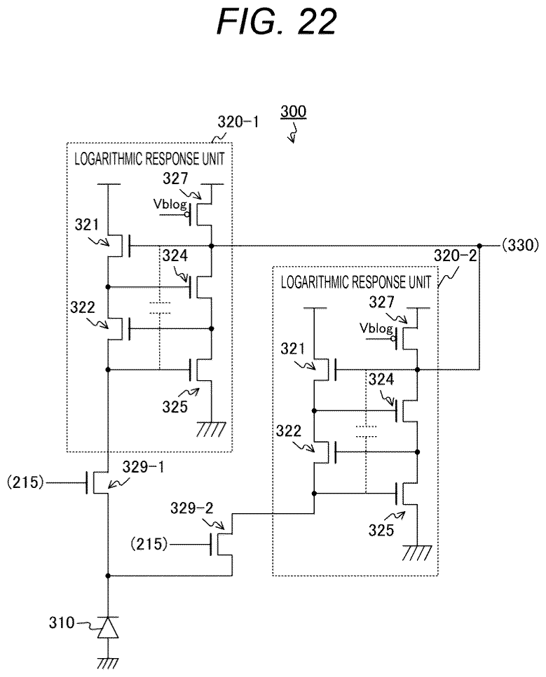

As illustrated in FIG. 22, logarithmic response units 320-1 and 320-2 having different coupling capacitors are disposed in the EVS pixel 300, and connection destinations of input nodes of these can be switched by the switches 329-1 and 329-2. In the figure, the switch 329-1 opens and closes a path between the input node of the logarithmic response unit 320-1 and the photoelectric conversion element 310, and the switch 329-2 opens and closes a path between the input node of the logarithmic response unit 320-2 and the photoelectric conversion element 310. The output nodes of the respective logarithmic response units 320-1 and 320-2 are connected in common to the buffer 330 at the subsequent stage. The parameter control circuit 215 selects one of the logarithmic response units 320-1 and 320-2 in accordance with illuminance, and controls the switches 329-1 and 329-2 to connect to the photoelectric conversion element 310.

Furthermore, in the figure, connection destinations of the input nodes of the logarithmic response units 320-1 and 320-2 are switched, but the connection destinations of the output nodes can also be switched.

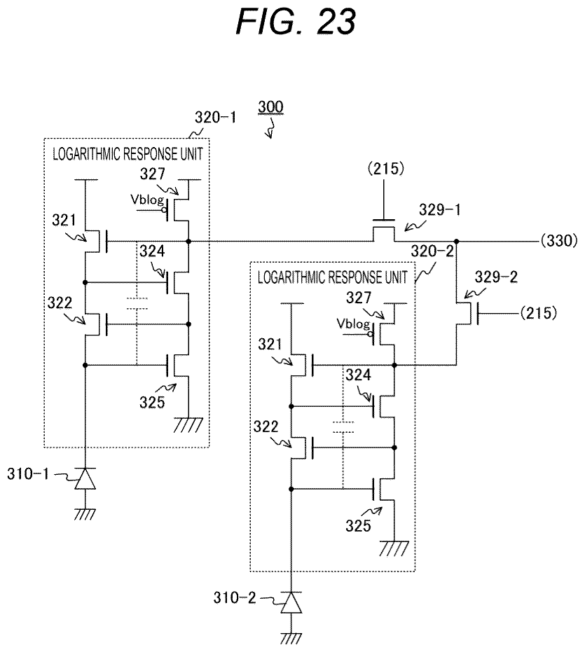

For example, as illustrated in FIG. 23, a photoelectric conversion element 310-1 is connected to the input node of the logarithmic response unit 320-1, and a photoelectric conversion element 310-2 is connected to the input node of the logarithmic response unit 320-2. Then, the switch 329-1 opens and closes a path between the output node of the logarithmic response unit 320-1 and the buffer 330, and the switch 329-2 opens and closes a path between the output node of the logarithmic response unit 320-2 and the buffer 330. The parameter control circuit 215 selects one of the logarithmic response units 320-1 and 320-2 in accordance with illuminance, and controls the switches 329-1 and 329-2 to connect to the buffer 330. The circuit including the photoelectric conversion element 310-1 and the logarithmic response unit 320-1 functions as one of a pair of sub-pixels in the EVS pixel 300, and the circuit including the photoelectric conversion element 310-2 and the logarithmic response unit 320-2 functions as another one of the pair of sub-pixels.

In FIGS. 22 and 23, the parameter control circuit 215 switches the connection destinations of the two logarithmic response units, but three or more logarithmic response units having different coupling capacitors may be provided to switch the connection destinations.

Note that, in addition to the capacitance value, the parameter control circuit 215 can also control a bias voltage to at least one of the buffer 330, a differentiator 340, or a comparator 350.

As described above, according to the second embodiment of the present technology, since the parameter control circuit 215 controls the capacitance value of the variable capacitor in the EVS pixel 300 in accordance with illuminance, noise can be suppressed.

### First Modification

In the second embodiment described above, the parameter control circuit 215 controls the capacitance value of the variable capacitor in the EVS pixel 300, but the present disclosure is not limited to this configuration. A solid-state imaging element 200 according to a first modification of the second embodiment is different from that of the second embodiment in that at least one of a plurality of EVS pixels having different coupling capacitors is read out.

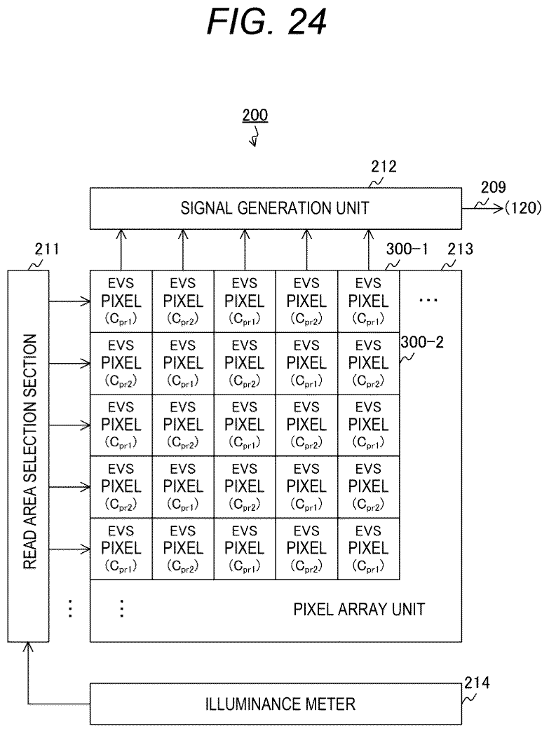

FIG. 24 is a block diagram illustrating a configuration example of the solid-state imaging element 200 according to the first modification of the second embodiment of the present technology. The solid-state imaging element 200 according to the first modification of the second embodiment includes a read area selection section 211, a signal generation unit 212, a pixel array unit 213, and an illuminance meter 214. Furthermore, in the pixel array unit 213, a predetermined number of EVS pixels 300-1 and a predetermined number of EVS pixels 300-2 are arranged in a two-dimensional lattice pattern. A coupling capacitor Con in the EVS pixel 300-1 has a value different from that of a coupling capacitor Cpr: in the EVS pixel 300-2. Note that the EVS pixels 300-1 and 300-2 are examples of first and second pixels described in the claims.

The illuminance meter 214 supplies measured illuminance to the read area selection section 211. The read area selection section 211 selects and reads one of the EVS pixels 300-1 and 300-2 in accordance with the illuminance. For example, the read area selection section 211 selects one of the EVS pixels 300-1 and 300-2 having a smaller coupling capacitor in a case where the illuminance is lower than a threshold value, and selects one having a larger coupling capacitor in a case where the illuminance is equal to or larger than the threshold value. As a result, noise can be suppressed similarly to the second embodiment.

Alternatively, the read area selection section 211 can also read all the EVS pixels. In this case, the subsequent circuit can perform processing according to various degrees of illuminance.

Note that three or more types of EVS pixels having different coupling capacitors may be arranged, and the read area selection section 211 may select at least one of the three or more types of EVS pixels.

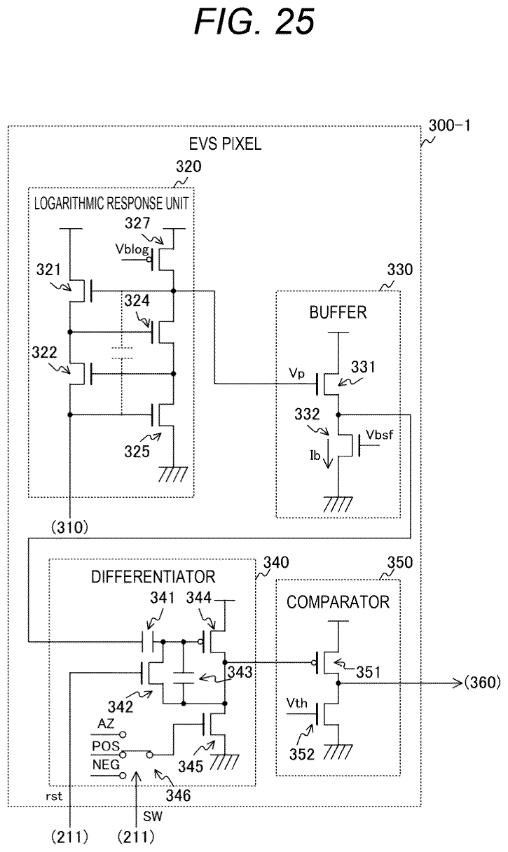

FIG. 25 is an example of a circuit diagram of the EVS pixel 300-1 according to the first modification of the second embodiment of the present technology. This EVS pixel 300-1 includes a photoelectric conversion element 310, a logarithmic response unit 320, a buffer 330, a differentiator 340, and a comparator 350. The coupling capacitor of the logarithmic response unit 320 has a fixed value. In circuits in and after the buffer 330, a bias voltage is a fixed value. A circuit configuration of the EVS pixel 300-2 is similar to that of the EVS pixel 300-1 except that the coupling capacitor is different.

As described above, according to the first modification of the second embodiment of the present technology, since the read area selection section 211 selects one of the EVS pixels 300-1 and 300-2 having different coupling capacitors in accordance with illuminance, noise can be suppressed.

### Second Modification

In the second embodiment described above, the parameter control circuit 215 controls the capacitance value of the variable capacitor in the EVS pixel 300 in accordance with illuminance, but can also control the capacitance value in accordance with a measured value other than the illuminance. A solid-state imaging element 200 according to a second modification of the second embodiment is different from that of the second embodiment in that a voltage is measured instead of illuminance, and a capacitance value of a variable capacitor is controlled in accordance with the voltage value.

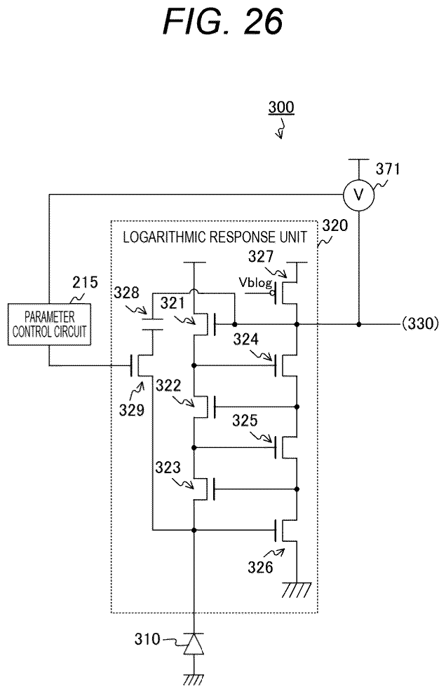

FIG. 26 is an example of a circuit diagram of an EVS pixel 300 according to the second modification of the second embodiment of the present technology. In the second modification of the second embodiment, the illuminance meter 214 is not disposed in the solid-state imaging element 200. Furthermore, a voltmeter 371 and a parameter control circuit 215 are further disposed in the pixel 300. Furthermore, a circuit configuration of a logarithmic response unit 320 of the second modification of the second embodiment is similar to that of the second embodiment.

The voltmeter 371 measures a voltage at an output node of the logarithmic response unit 320, and supplies a measured value to the parameter control circuit 215. Note that the voltmeter 371 is an example of a measurement unit described in the claims.

The parameter control circuit 215 controls a capacitance value of a variable capacitor in the logarithmic response unit 320 in accordance with the voltage value. For example, the parameter control circuit 215 controls a switch 329 to an off state in a case where the voltage value is lower than a threshold value, and turns the switch 329 to an on state to insert a coupling capacitor 328 in a case where the voltage value is equal to or larger than the threshold value. As a result, noise is suppressed.

Note that the parameter control circuit 215 controls the variable capacitor in accordance with the voltage value for every EVS pixel 300, but the present disclosure is not limited to this control. For example, the parameter control circuit 215 can obtain a statistic amount (average or total) of voltage values of all the pixels, and control the variable capacitor of each of all the pixels in accordance with the statistic amount. Alternatively, the parameter control circuit 215 can obtain, for every area, a statistic amount (average or total) of voltage values of the EVS pixels 300 in the area, and control the variable capacitor in the area in accordance with the statistic amount.

As described above, according to the second modification of the second embodiment of the present technology, since the parameter control circuit 215 controls the capacitance value of the variable capacitor in the EVS pixel 300 in accordance with the voltage value, noise can be suppressed.

### Third Modification

In the second embodiment described above, the parameter control circuit 215 controls the capacitance value of the variable capacitor in the EVS pixel 300 in accordance with illuminance, but can also control the capacitance value in accordance with a measured value other than the illuminance. A solid-state imaging element 200 according to a third modification of the second embodiment is different from that of the second embodiment in that a current is measured instead of illuminance, and a capacitance value of a variable capacitor is controlled in accordance with the current value.

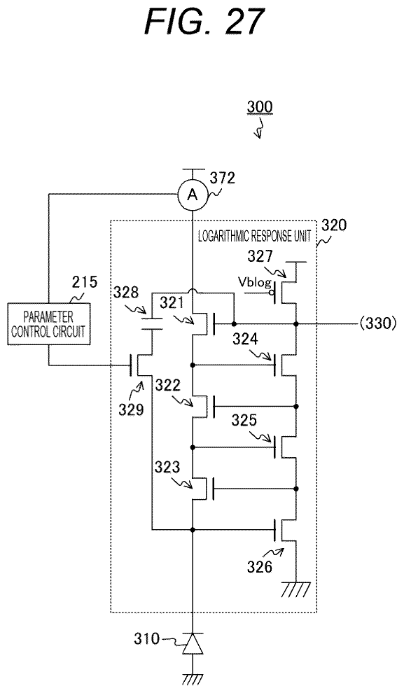

FIG. 27 is an example of a circuit diagram of an EVS pixel 300 according to the third modification of the second embodiment of the present technology. In the third modification of the second embodiment, the illuminance meter 214 is not disposed in the solid-state imaging element 200. Furthermore, an ammeter 372 and a parameter control circuit 215 are further disposed in the pixel 300. Furthermore, a circuit configuration of the logarithmic response unit 320 of the third modification of the second embodiment is similar to that of the second embodiment.

The ammeter 372 measures a current flowing through a logarithmic response unit 320, and supplies a measured value to the parameter control circuit 215. Note that the ammeter 372 is an example of a measurement unit described in the claims.

The parameter control circuit 215 controls a capacitance value of a variable capacitor in the logarithmic response unit 320 in accordance with a current value. For example, the parameter control circuit 215 controls a switch 329 to an off state in a case where the current value is smaller than a threshold value, and turns the switch 329 to an on state to insert a coupling capacitor 328 in a case where the current value is equal to or larger than the threshold value. As a result, noise is suppressed.

Note that the parameter control circuit 215 controls the variable capacitor in accordance with the current value for every EVS pixel 300, but the present disclosure is not limited to this control. For example, the parameter control circuit 215 can obtain a statistic amount (average or total) of current values of all the pixels, and control the variable capacitor of each of all the pixels in accordance with the statistic amount. Alternatively, the parameter control circuit 215 can obtain, for every area, a statistic amount (average or total) of current values of the EVS pixels 300 in the area, and control the variable capacitor in the area in accordance with the statistic amount.

As described above, according to the third modification of the second embodiment of the present technology, since the parameter control circuit 215 controls the capacitance value of the variable capacitor in the EVS pixel 300 in accordance with the current value, noise can be suppressed.

### 3. Third Embodiment

In the first embodiment described above, the illuminance meter 214 is disposed outside the pixel array unit 213, but the present disclosure is not limited to this configuration. A solid-state imaging element 200 according to a third embodiment is different from that in the first embodiment in that a part of an illuminance meter is disposed in a pixel array unit 213.

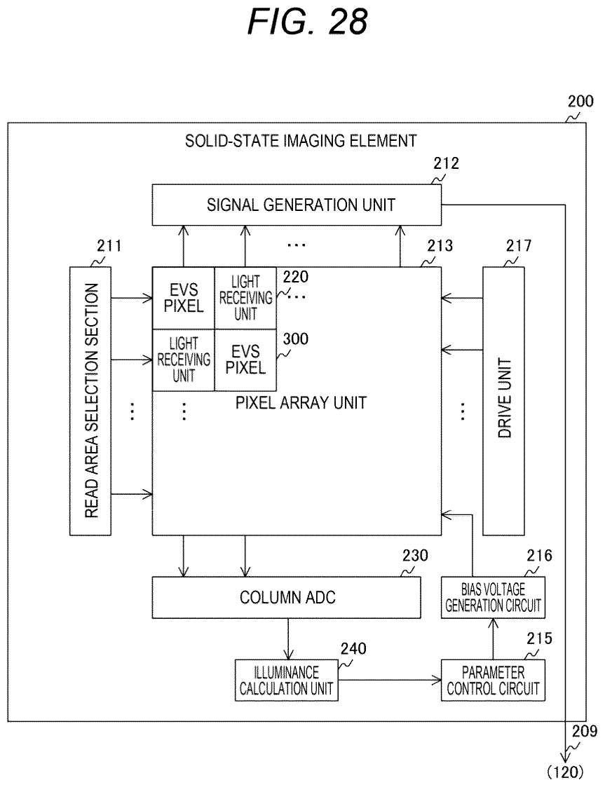

FIG. 28 is a block diagram illustrating a configuration example of the solid-state imaging element 200 according to the third embodiment of the present technology. The solid-state imaging element 200 according to the third embodiment is different from that of the first embodiment in further including a drive unit 217, and including a predetermined number of light receiving units 220, a column ADC 230, and an illuminance calculation unit 240, instead of the illuminance meter 214.

The predetermined number of light receiving units 220 are arranged in the pixel array unit 213. Each of these light receiving units 220 can be used as a grayscale pixel that generates a grayscale signal. For example, two pixels out of four pixels of two rows×two columns in the pixel array unit 213 are replaced with the light receiving unit 220 (in other words, grayscale pixels). Note that a ratio of the number of pixels and an area between the grayscale pixel and an EVS pixel 300 is not limited to 1:1. For example, the number of pixels of the grayscale pixel may be made larger than that of the EVS pixel 300, and the area of the grayscale pixel may be made smaller than that of the EVS pixel 300.

The drive unit 217 drives each of the light receiving units 220. The light receiving unit 220 generates an analog signal according to brightness, and supplies the analog signal to the column ADC 230. The column ADC 230 converts the analog signal into a digital signal for every column, and supplies the digital signal to the illuminance calculation unit 240. The illuminance calculation unit 240 calculates illuminance on the basis of the digital signal, and supplies the illuminance to a parameter control circuit 215.

Furthermore, the column ADC 230 can output data in which digital signals are arranged as image data.

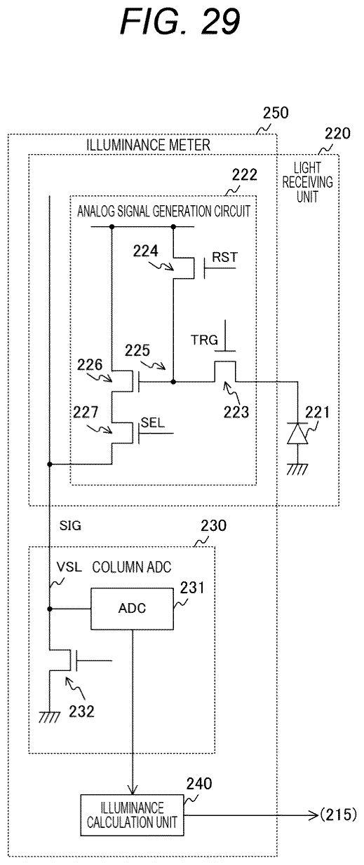

FIG. 29 is a circuit diagram illustrating a configuration example of the light receiving unit 220 and the column ADC 230 according to the third embodiment of the present technology.

The light receiving unit 220 includes a photoelectric conversion element 221 and an analog signal generation circuit 222. The analog signal generation circuit 222 includes a transfer transistor 223, a reset transistor 224, a floating diffusion layer 225, an amplifier transistor 226, and a selection transistor 227.

The photoelectric conversion element 221 generates a charge by photoelectric conversion. Note that the photoelectric conversion element 310 in the EVS pixel 300 is an example of a first photoelectric conversion element described in the claims, and the photoelectric conversion element 221 is an example of a second photoelectric conversion element described in the claims.

The transfer transistor 223 transfers a charge from the photoelectric conversion element 221 to the floating diffusion layer 225 in accordance with a transfer signal TRG from the drive unit 217. The reset transistor 224 initializes the floating diffusion layer 225 in accordance with a reset signal RST from the drive unit 217. The amplifier transistor 226 amplifies a voltage of the floating diffusion layer 225 to generate an analog signal. The selection transistor 227 supplies the analog signal to a vertical signal line VSL in accordance with a selection signal SEL from the drive unit 217. The vertical signal line VSL is wired for every column of the light receiving unit 220.

The column ADC 230 includes an ADC 231 and a load MOS transistor 232 for every column of the light receiving unit 220. The ADC 231 converts an analog signal from the corresponding vertical signal line VSL into a digital signal, and supplies the digital signal to the illuminance calculation unit 240. For example, a single-slope ADC is used as the ADC 231. The load MOS transistor 232 supplies a constant current.

The illuminance calculation unit 240 calculates a statistic amount (average or total) of values of the digital signals from the light receiving unit 220 within a photometric range, and supplies the value to the parameter control circuit 215 as illuminance.

A circuit including all the analog signal generation circuits 222, the column ADC 230, and the illuminance calculation unit 240 functions as an illuminance meter 250.

As described above, by disposing a part of the illuminance meter 250 in the pixel array unit 213, illuminance of the pixel array unit 213 can be accurately measured as compared with the first embodiment in which the illuminance meter 214 is disposed outside the pixel array unit 213.

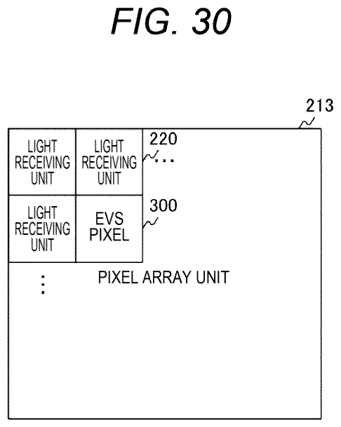

Note that, as illustrated in FIG. 30, the EVS pixels 300 can be arranged at a constant cycle in the pixel array unit 213. In the figure, in a pixel block of two rows×two columns, the EVS pixel is disposed in the lower right, and the light receiving units 220 are disposed in the rest.

Note that the second embodiment and the first and second modifications of the first embodiment can be applied to the third embodiment.

As described above, according to the third embodiment of the present technology, since a part of the illuminance meter 250 is disposed in the pixel array unit 213, illuminance of the pixel array unit 213 can be accurately measured.

### First Modification

In the third embodiment described above, the photoelectric conversion element is disposed in each of the light receiving unit 220 and the EVS pixel 300. However, in this configuration, a light receiving area of every pixel may be insufficient. A solid-state imaging element 200 according to a first modification of the third embodiment is different from that of the first embodiment in that a light receiving unit 220 and an EVS pixel 300 share one photoelectric conversion element.

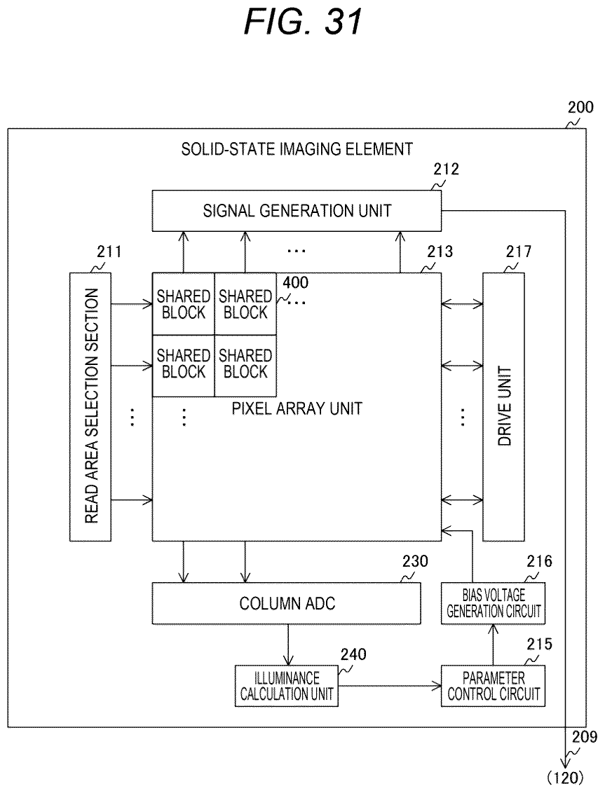

FIG. 31 is a block diagram illustrating a configuration example of the solid-state imaging element 200 according to the first modification of the third embodiment of the present technology. The solid-state imaging element 200 according to the first modification of the third embodiment is different from that of the third embodiment in that a predetermined number of shared blocks 400 are arranged in a pixel array unit 213.

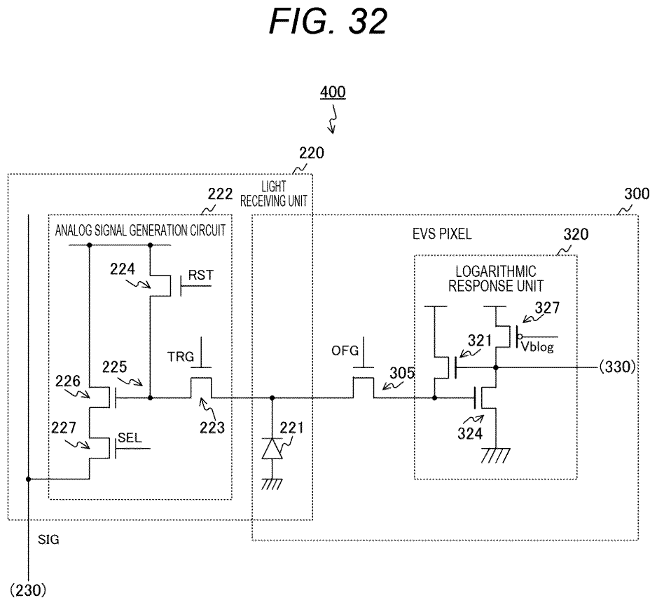

FIG. 32 is a circuit diagram illustrating a configuration example of the shared block 400 according to the first modification of the third embodiment of the present technology. The shared block 400 includes the light receiving unit 220, an OFG transistor 305, a logarithmic response unit 320, a buffer 330, a differentiator 340, a comparator 350, and an output circuit 360. In the figure, the buffer 330, the differentiator 340, the comparator 350, and the output circuit 360 are omitted.

The OFG transistor 305 opens and closes a path between the logarithmic response unit 320 and a photoelectric conversion element 221 in the light receiving unit 220, in accordance with a control signal OFG from a read area selection section 211.

A circuit including the photoelectric conversion element 221, the OFG transistor 305, the logarithmic response unit 320, the buffer 330, the differentiator 340, the comparator 350, and the output circuit 360 functions as the EVS pixel 300.

With the circuit configuration described above, the light receiving unit 220 and the EVS pixel 300 share one photoelectric conversion element 221. In a case of measuring illuminance or generating a grayscale signal, a transfer transistor 223 is controlled to an on state, and the OFG transistor 305 is controlled to an off state.

Whereas, in a case of detecting an address event, the transfer transistor 223 is controlled to an off state, and the OFG transistor 305 is controlled to an on state.

As illustrated in the figure, since the light receiving unit 220 and the EVS pixel 300 share the photoelectric conversion element 221, a light receiving area per pixel can be widened as compared with a case where the photoelectric conversion element is disposed in each of the light receiving unit 220 and the EVS pixel 300.

Note that the second embodiment and the first and second modifications of the first embodiment can be applied to the first modification of the third embodiment.

As described above, according to the first modification of the third embodiment of the present technology, since the light receiving unit 220 and the EVS pixel 300 share one photoelectric conversion element 221, the light receiving area per pixel can be widened as compared with the third embodiment.

### Second Modification

In the third embodiment described above, the light receiving unit 220 is disposed in the pixel array unit 213, but the present disclosure is not limited to this configuration. A solid-state imaging element 200 according to a second modification of the third embodiment is different from that of the third embodiment in that a circuit scale of an illuminance meter 250 is reduced.

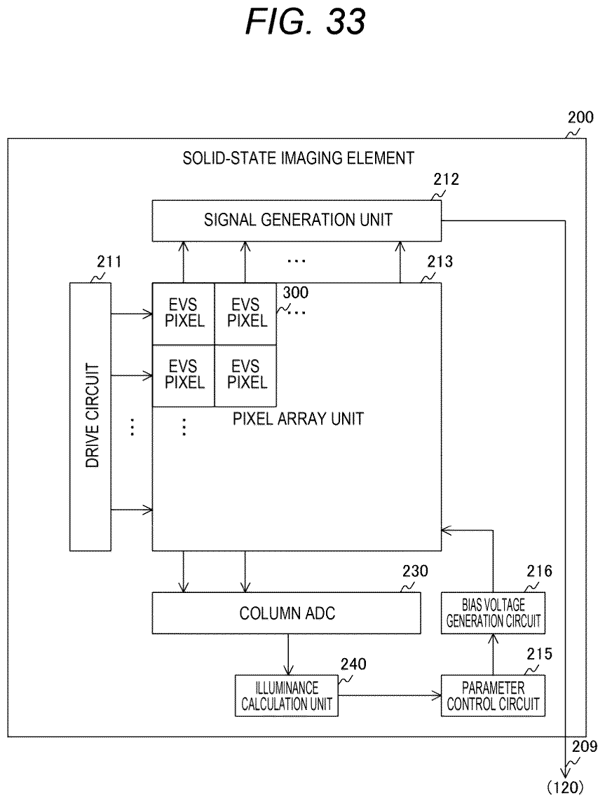

FIG. 33 is a block diagram illustrating a configuration example of the solid-state imaging element 200 according to the second modification of the third embodiment of the present technology. The solid-state imaging element 200 according to the second modification of the third embodiment is different from that of the third embodiment in that only EVS pixels 300 are arranged in a pixel array unit 213.

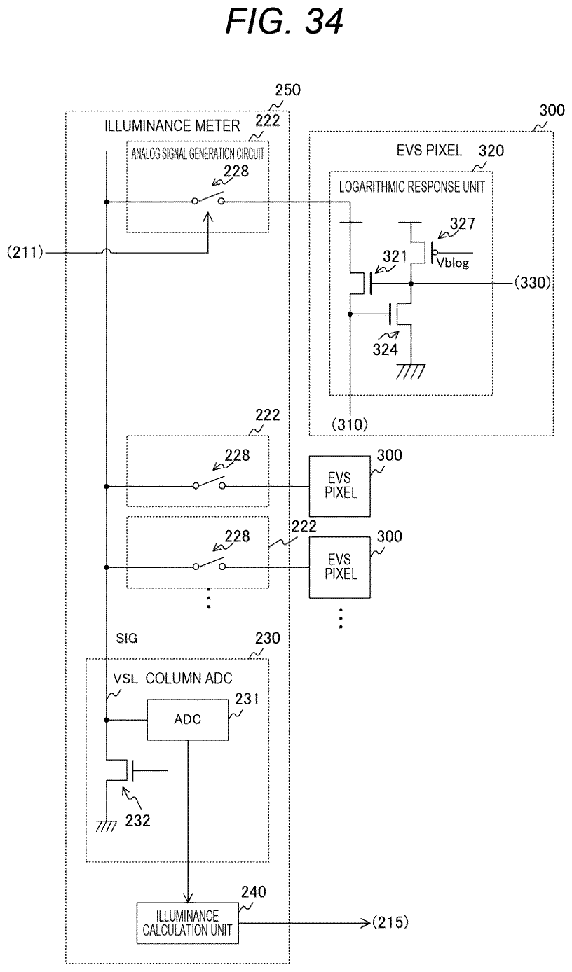

FIG. 34 is a circuit diagram illustrating a configuration example of the illuminance meter 250 according to the second modification of the third embodiment of the present technology. In the second modification of the third embodiment, when the number of rows is R (R is an integer), each of R pieces of analog signal generation circuits 222 is disposed for each corresponding column in the pixel array unit 213. Each of the analog signal generation circuits 222 includes a changeover switch 228. An r-th (r is an integer from 1 to R) changeover switch 228 is disposed in an r-th row.

The changeover switch 228 connects a vertical signal line VSL to a power supply node of a logarithmic response unit 320 in the corresponding EVS pixel 300, under the control of the read area selection section 211. The changeover switch 228 is controlled to an on state during a period for measuring illuminance, and the changeover switch 228 is controlled to an off state during a period for detecting an address event.

Since only the changeover switch 228 is disposed in the analog signal generation circuit 222 as illustrated in the figure, a circuit scale of the illuminance meter 250 can be reduced as compared with the third embodiment.

Note that the second embodiment and the first and second modifications of the first embodiment can be applied to the second modification of the third embodiment.

As described above, according to the second modification of the third embodiment of the present technology, since only the changeover switch 228 is disposed in the analog signal generation circuit 222, the circuit scale of the illuminance meter 250 can be reduced.

### 4. Example of Application to Mobile Body

The technology according to the present disclosure (the present technology) can be applied to various products. For example, the technology according to the present disclosure may be embodied in the form of a device to be mounted on a mobile body of any kind, such as an automobile, an electric vehicle, a hybrid electric vehicle, a motorcycle, a bicycle, a personal mobility, an airplane, a drone, a vessel, or a robot.

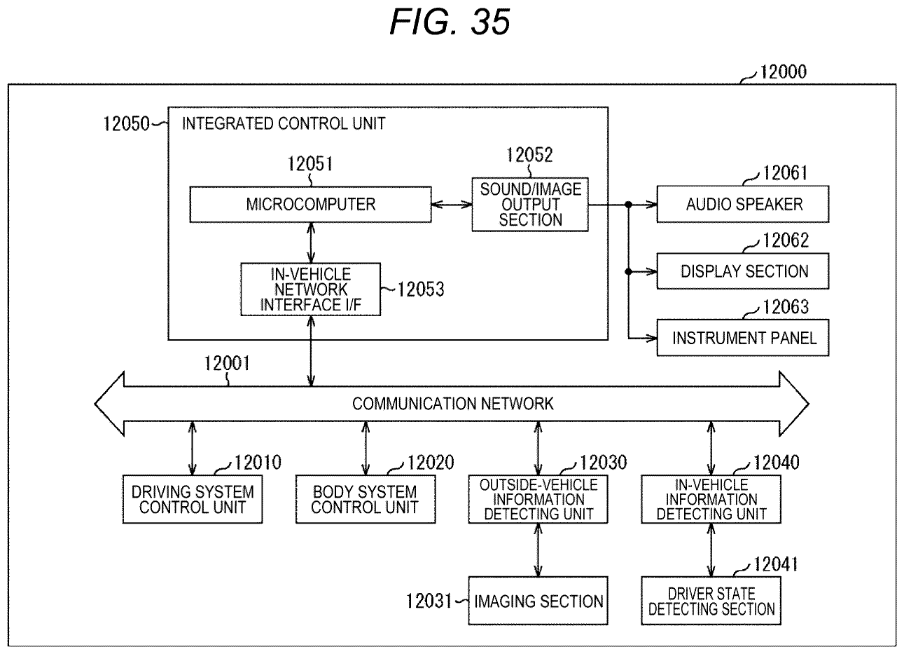

FIG. 35 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 35, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and an in-vehicle network interface (I/F) 12053 are illustrated as functional configurations of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 35, an audio speaker 12061, a display section 12062, and an instrument panel 12063 are illustrated as the output device. The display section 12062 may, for example, include at least one of an on-board display and a head-up display.

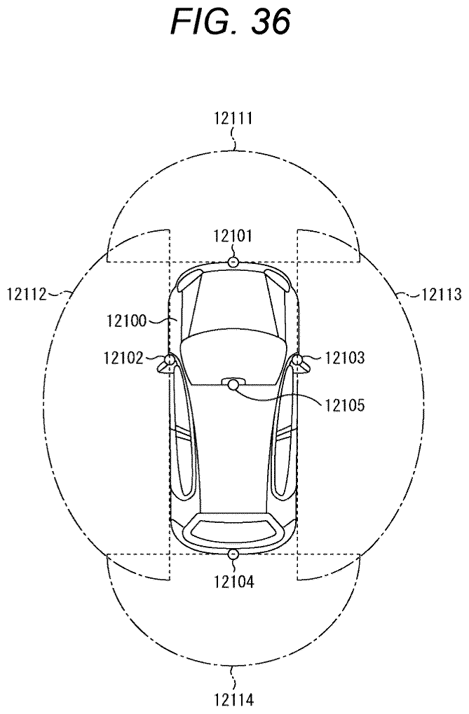

FIG. 36 is a diagram illustrating an example of the installation position of the imaging section 12031.

In FIG. 36, imaging sections 12101, 12102, 12103, 12104, and 12105 are included as the imaging section 12031.

The imaging sections 12101, 12102, 12103, 12104, and 12105 are, for example, provided at positions on a front nose, sideview mirrors, a rear bumper, and a back door of a vehicle 12100 as well as a position on an upper portion of a windshield in the interior of the vehicle, or the like. The imaging section 12101 provided to the front nose and the imaging section 12105 provided to the upper portion of the windshield within the interior of the vehicle obtain mainly an image of the front of the vehicle 12100. The imaging sections 12102 and 12103 provided for the sideview mirrors mainly obtain images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that, FIG. 36 illustrates an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the above, an example has been described of the vehicle control system to which the technology according to the present disclosure is applicable. The technology according to the present disclosure is applicable to the imaging section 12031, for example, among the configurations described above. Specifically, the imaging device 100 in FIG. 1 can be applied to the imaging section 12031. By applying the technology according to the present disclosure to the imaging section 12031, it is possible to suppress noise and obtain higher quality data.

Note that the embodiments described above indicate examples for embodying the present technology, and the respective matters in the embodiments and the respective matters specifying the invention in the claims have correspondence relationships. Similarly, the respective matters specifying the invention in the claims and the respective matters with the same names in the embodiments of the present technology have correspondence relationships. Note that the present technology is not limited to the embodiments, and can be embodied by applying various kinds of modification to the embodiments without departing from the scope of the present technology.

Note that the effects described herein are merely illustrative and not limiting, and other effects may also be present.

Note that the present technology can also have the following configurations.
(1) A solid-state imaging element including:
an illuminance meter configured to measure illuminance;
a detection pixel configured to detect whether or not an amount of change in brightness exceeds a threshold value that is predetermined; and
a parameter control circuit configured to control a parameter of the detection pixel in accordance with the measured illuminance.
(2) The solid-state imaging element according to (1) above, in which
the detection pixel includes:
a photoelectric conversion element configured to generate a photocurrent;
a logarithmic response unit configured to convert the photocurrent into a logarithmic voltage;
a buffer configured to output an output signal according to the logarithmic voltage;
a differentiator configured to differentiate the output signal, and supply a differential signal; and
a comparator configured to compare the differential signal with a threshold value that is predetermined.
(3) The solid-state imaging element according to (2) above, further including:
a bias voltage generation circuit configured to generate a bias voltage under control of the parameter control circuit and supply the bias voltage to the detection pixel, in which
the parameter includes the bias voltage.
(4) The solid-state imaging element according to (3) above, in which
the bias voltage includes a first bias voltage, and
the bias voltage generation circuit supplies the first bias voltage to the buffer.
(5) The solid-state imaging element according to (3) or (4) above, in which
the bias voltage includes a second bias voltage, and
the bias voltage generation circuit supplies the second bias voltage to the differentiator.
(6) The solid-state imaging element according to any one of (3) to (5) above, in which
the bias voltage includes a third bias voltage, and
the bias voltage generation circuit supplies the third bias voltage indicating the threshold value to the comparator.
(7) The solid-state imaging element according to any one of (2) to (6) above, in which
the detection pixel includes a variable capacitor, and
the parameter includes a capacitance value of the variable capacitor.
(8) The solid-state imaging element according to (7) above, in which
the variable capacitor is inserted between an input node and an output node of the logarithmic response unit.
(9) The solid-state imaging element according to (7) above, in which
the variable capacitor is inserted between a predetermined reference voltage and an output node of the logarithmic response unit.
(10) The solid-state imaging element according to any one of (1) to (9) above, in which
the parameter control circuit controls the parameter to a different value between a case where the illuminance is within a predetermined range and a case where the illuminance is out of the predetermined range.
(11) The solid-state imaging element according to any one of (1) to (10) above, in which
the detection pixel is arranged in a pixel array unit, and
the illuminance meter is disposed outside the pixel array unit.
(12) The solid-state imaging element according to any one of (1) to (10) above, in which
the illuminance meter includes:
an analog signal generation circuit configured to generate an analog signal according to brightness;
an analog-to-digital converter configured to convert the analog signal into a digital signal; and
an illuminance calculation unit configured to calculate illuminance from the digital signal, and
the analog signal generation circuit and the detection pixel are arranged in a pixel array unit.
(13) The solid-state imaging element according to (12) above, in which
the detection pixel includes a first photoelectric conversion element, and
the analog signal generation circuit includes:
a transfer transistor configured to transfer a charge from a second photoelectric conversion element to a floating diffusion layer;
a reset transistor configured to initialize the floating diffusion layer;
an amplifier transistor configured to generate the analog signal by amplifying a voltage of the floating diffusion layer; and
a selection transistor configured to supply the analog signal to the analog-to-digital converter in accordance with a selection signal.
(14) The solid-state imaging element according to (12) above, in which
the detection pixel includes a photoelectric conversion element, and
the analog signal generation circuit includes:
a transfer transistor configured to transfer a charge from the photoelectric conversion element to a floating diffusion layer;
a reset transistor configured to initialize the floating diffusion layer;
an amplifier transistor configured to generate the analog signal by amplifying a voltage of the floating diffusion layer; and
a selection transistor configured to supply the analog signal to the analog-to-digital converter in accordance with a selection signal.
(15) The solid-state imaging element according to (12) above, in which
the detection pixel includes:
a photoelectric conversion element configured to generate a photocurrent; and
a logarithmic response unit configured to convert the photocurrent into a logarithmic voltage, and
the analog signal generation circuit includes a changeover switch configured to connect between a power supply node of the logarithmic response unit and the analog-to-digital converter.
(16) A method for controlling a solid-state imaging element, the method including:
a procedure of measuring illuminance;
a procedure of detecting whether or not an amount of change in brightness exceeds a threshold value that is predetermined; and
a procedure of controlling a parameter of the detection pixel in accordance with the measured illuminance.
(17) A solid-state imaging element including:
a measurement unit configured to measure a value of an electric signal and output a measured value;
a detection pixel configured to detect whether or not an amount of change in brightness exceeds a threshold value that is predetermined; and
a parameter control circuit configured to control a parameter of the detection pixel in accordance with the measured value.
(18) The solid-state imaging element according to (17) above, in which
the measured value is a value of a current flowing through the detection pixel.
(19) The solid-state imaging element according to (17) above, in which
the measured value is a value of a voltage at a predetermined node in the detection pixel.
(20) A solid-state imaging element including:
an illuminance meter configured to measure illuminance;
a first pixel including a first capacitor;
a second pixel including a second capacitor; and
a read area selection section configured to read one of the first and second pixels in accordance with the illuminance.

### REFERENCE SIGNS LIST

100 Imaging device
110 Imaging lens
120 Recording section
130 Control unit
200 Solid-state imaging element
211 Read area selection section
212 Signal generation unit
213 Pixel array unit
214, 250 Illuminance meter
215 Parameter control circuit
216 Bias voltage generation circuit
217 Drive unit
220 Light receiving unit
221, 310, 310-1, 310-2 Photoelectric conversion element
222 Analog signal generation circuit
223 Transfer transistor
224 Reset transistor
225 Floating diffusion layer
226 Amplifier transistor
227 Selection transistor
228 Changeover switch
230 Column ADC
231 ADC
232 Load MOS transistor
240 Illuminance calculation unit
300, 300-1, 300-2 EVS pixel
305 OFG transistor
320, 320-1, 320-2 Logarithmic response unit
321, 322, 323 Log transistor
322-1, 323-1 nMOS transistor
324, 325, 326 TIA
327 Current source transistor
328, 328-1, 328-2 Coupling capacitor
329, 329-1, 329-2 Switch
341, 343 Capacitor
330 Buffer
331 Source follower transistor
332, 342, 345, 352 nMOS transistor
340 Differentiator
344, 351 pMOS transistor
346 Bias changeover switch
350 Comparator
360 Output circuit
371 Voltmeter
372 Ammeter
400 Shared block
12031 Imaging section

1. A solid-state imaging element comprising:
an illuminance meter configured to measure illuminance;
a detection pixel configured to detect whether or not an amount of change in brightness exceeds a threshold value that is predetermined; and
a parameter control circuit configured to control a parameter of the detection pixel in accordance with the measured illuminance.

2. The solid-state imaging element according to claim 1, wherein
the detection pixel includes:
a photoelectric conversion element configured to generate a photocurrent;
a logarithmic response unit configured to convert the photocurrent into a logarithmic voltage;
a buffer configured to output an output signal according to the logarithmic voltage;
a differentiator configured to differentiate the output signal, and supply a differential signal; and
a comparator configured to compare the differential signal with a threshold value that is predetermined.

3. The solid-state imaging element according to claim 2, further comprising:
a bias voltage generation circuit configured to generate a bias voltage under control of the parameter control circuit and supply the bias voltage to the detection pixel, wherein
the parameter includes the bias voltage.

4. The solid-state imaging element according to claim 3, wherein
the bias voltage includes a first bias voltage, and
the bias voltage generation circuit supplies the first bias voltage to the buffer.

5. The solid-state imaging element according to claim 3, wherein
the bias voltage includes a second bias voltage, and
the bias voltage generation circuit supplies the second bias voltage to the differentiator.

6. The solid-state imaging element according to claim 3, wherein
the bias voltage includes a third bias voltage, and
the bias voltage generation circuit supplies the third bias voltage indicating the threshold value to the comparator.

7. The solid-state imaging element according to claim 2, wherein
the detection pixel includes a variable capacitor, and
the parameter includes a capacitance value of the variable capacitor.

8. The solid-state imaging element according to claim 7, wherein
the variable capacitor is inserted between an input node and an output node of the logarithmic response unit.

9. The solid-state imaging element according to claim 7, wherein
the variable capacitor is inserted between a predetermined reference voltage and an output node of the logarithmic response unit.

10. The solid-state imaging element according to claim 1, wherein
the parameter control circuit controls the parameter to a different value between a case where the illuminance is within a predetermined range and a case where the illuminance is out of the predetermined range.

11. The solid-state imaging element according to claim 1, wherein
the detection pixel is arranged in a pixel array unit, and
the illuminance meter is disposed outside the pixel array unit.

12. The solid-state imaging element according to claim 1, wherein
the illuminance meter includes:
an analog signal generation circuit configured to generate an analog signal according to brightness;
an analog-to-digital converter configured to convert the analog signal into a digital signal; and
an illuminance calculation unit configured to calculate illuminance from the digital signal, and
the analog signal generation circuit and the detection pixel are arranged in a pixel array unit.

13. The solid-state imaging element according to claim 12, wherein
the detection pixel includes a first photoelectric conversion element, and
the analog signal generation circuit includes:
a transfer transistor configured to transfer a charge from a second photoelectric conversion element to a floating diffusion layer;
a reset transistor configured to initialize the floating diffusion layer;
an amplifier transistor configured to generate the analog signal by amplifying a voltage of the floating diffusion layer; and
a selection transistor configured to supply the analog signal to the analog-to-digital converter in accordance with a selection signal.

14. The solid-state imaging element according to claim 12, wherein
the detection pixel includes a photoelectric conversion element, and
the analog signal generation circuit includes:
a transfer transistor configured to transfer a charge from a photoelectric conversion element to a floating diffusion layer;
a reset transistor configured to initialize the floating diffusion layer;
an amplifier transistor configured to generate the analog signal by amplifying a voltage of the floating diffusion layer; and
a selection transistor configured to supply the analog signal to the analog-to-digital converter in accordance with a selection signal.

15. The solid-state imaging element according to claim 12, wherein
the detection pixel includes:
a photoelectric conversion element configured to generate a photocurrent; and
a logarithmic response unit configured to convert the photocurrent into a logarithmic voltage, and
the analog signal generation circuit includes a changeover switch configured to connect between a power supply node of the logarithmic response unit and the analog-to-digital converter.

16. A method for controlling a solid-state imaging element, the method comprising:
a procedure of measuring illuminance;
a procedure of detecting whether or not an amount of change in brightness exceeds a threshold value that is predetermined; and
a procedure of controlling a parameter of the detection pixel in accordance with the measured illuminance.

17. A solid-state imaging element comprising:
a measurement unit configured to measure a value of an electric signal and output a measured value;
a detection pixel configured to detect whether or not an amount of change in brightness exceeds a threshold value that is predetermined; and
a parameter control circuit configured to control a parameter of the detection pixel in accordance with the measured value.

18. The solid-state imaging element according to claim 17, wherein
the measured value is a value of a current flowing through the detection pixel.

19. The solid-state imaging element according to claim 17, wherein
the measured value is a value of a voltage at a predetermined node in the detection pixel.

20. A solid-state imaging element comprising:
an illuminance meter configured to measure illuminance;
a first pixel including a first capacitor;
a second pixel including a second capacitor; and
a read area selection section configured to read one of the first and second pixels in accordance with the illuminance.
